(19) United States
(12) Patent Application Publication
(10) Pub. No.: US 2026/0261921 A1
(43) Pub. Date: Sep. 3, 2026

(54) NODE AND USER EQUIPMENT IN WIRELESS COMMUNICATION SYSTEM AND METHOD PERFORMED BY THE SAME

(71) Applicant: Samsung Electronics Co., Ltd., Suwon-si, Gyeonggi-do (KR)

(72) Inventors: Yu PAN, Beijing (CN); Weiwei WANG, Beijing (CN); Hong WANG, Beijing (CN); Lixiang XU, Beijing (CN)

(21) Appl. No.: 19/163,197

(22) PCT Filed: Apr. 3, 2024
(86) PCT No.: PCT/KR2024/095661

§ 371 Date: Sep. 8, 2025

(30) Foreign Application Priority Data
Apr. 4, 2023 (CN) 202310358002.7

(51) Int. Cl. H04W 36/00; H04L 43/0882; H04W 76/20

(52) U.S. Cl. CPC H04W 36/0058; H04L 43/0882; H04W 76/20

(57) ABSTRACT

The present disclosure provides a node and a user equipment in a wireless communication system and methods performed by the same. A method performed by a first node in a wireless communication system provided by embodiments of the present disclosure includes: receiving, from a user equipment (UE), a first L1 measurement report, wherein the first L1 measurement report includes L1 measurement results of one or more candidate secondary cells; and transmitting secondary cell information to the UE, wherein the secondary cell information includes state information of one or more secondary cells, wherein the state information indicates an activated state or a deactivated state of each of the one or more secondary cells.

### TECHNICAL FIELD

The present disclosure relates to a field of wireless communication technologies, and in particular, to a node and a user equipment in a wireless communication system and methods performed by the same.

### BACKGROUND ART

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”

### DISCLOSURE OF INVENTION

### Technical Problem

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### Solution to Problem

Embodiments of the present disclosure provide a method performed by a first node in a wireless communication system, including: receiving, from a user equipment (UE), a first L1 measurement report, wherein the first L1 measurement report includes L1 measurement results of one or more candidate secondary cells; and transmitting secondary cell information to the UE, wherein the secondary cell information includes state information of one or more secondary cells, wherein the state information indicates an activated state or a deactivated state of each of the one or more secondary cells.

According to embodiments of the present disclosure, the method further includes: transmitting a message indicating cell switch to the UE, wherein the message indicating cell switch includes the secondary cell information, wherein the message indicating cell switch includes a target cell identifier of a target cell for cell switch and/or secondary cell information of a target secondary cell corresponding to the target cell.

According to embodiments of the present disclosure, the method further includes: receiving, from a third node, load status information from a second node, wherein the load status information includes a load status of each of the one or more candidate secondary cells; and transmitting target secondary cell information to the third node, wherein the target secondary cell information is transmitted to the second node through the third node.

According to embodiments of the present disclosure, the method further includes: determining the secondary cell information according to the first L1 measurement report and/or the load status information.

According to embodiments of the present disclosure, the method further includes: receiving the secondary cell information from a third node, wherein the secondary cell information is determined and transmitted to the third node by a second node.

According to embodiments of the present disclosure, the method further includes: transmitting a radio resource control (RRC) reconfiguration message to the UE, wherein the RRC reconfiguration message includes the secondary cell information.

According to embodiments of the present disclosure, the method further includes: transmitting, to a third node, the L1 measurement results of the one or more candidate secondary cells and/or identification information of a candidate secondary cell suggested to be activated, wherein the L1 measurement result of the one or more candidate secondary cells and/or the identification information of the candidate secondary cell suggested to be activated is transmitted to a second node through the third node for determining candidate secondary cell information, wherein the identification information of the candidate secondary cell suggested to be activated is determined based on the first L1 measurement report.

According to embodiments of the present disclosure, the method further includes: transmitting, to a third node, an L1 measurement result of a target secondary cell corresponding to a target cell for cell switch and/or identification information of a target secondary cell suggested to be activated, wherein the L1 measurement result of the target secondary cell corresponding to the target cell for cell switch and/or the identification information of the target secondary cell suggested to be activated is transmitted to a second node through the third node for determining target secondary cell information, wherein the target cell and the identification information of the target secondary cell suggested to be activated is determined based on the first L1 measurement report.

According to embodiments of the present disclosure, the method further includes: receiving from the UE a third L1 measurement report, wherein the third L1 measurement report includes L1 measurement results of one or more source candidate secondary cells; and transmitting a source secondary cell activation/deactivation media access control (MAC) control element (CE) to the UE for indicating an activated state or deactivated state of each of the one or more source secondary cells.

Embodiments of the present disclosure provides a method performed by a second node in a wireless communication system, including: transmitting, to a third node, load status information, wherein the load status information includes load status of one or more candidate secondary cells, wherein the load status information is transmitted to a first node through the third node; and receiving, from the third node, target secondary cell information, wherein the target secondary cell information is received from the first node by the third node.

According to embodiments of the present disclosure, the method further includes: monitoring a load status of a cell in the second node; if the load status of the cell changes, determining an updated load status of the cell; and including the updated load status in the load status information.

Embodiments of the present disclosure provides a method performed by a second node in a wireless communication system, including: receiving, from a third node, a measurement report, wherein the measurement report is received from a first node by the third node; and transmitting secondary cell information to a user equipment (UE) and/or the third node, wherein the secondary cell information includes state information of one or more secondary cells, wherein the state information indicates an activated state or a deactivated state of each of the one or more secondary cells, wherein in the case of transmitting the secondary cell information to the third node, the secondary cell information is transmitted to the first node through the third node.

According to embodiments of the present disclosure, the transmitting secondary cell information to the third node further includes: receiving L1 measurement results of one or more candidate secondary cells from the third node and/or identification information of a candidate secondary cell suggested to be activated; and transmitting secondary cell information of the one or more candidate secondary cells to the third node.

According to embodiments of the present disclosure, the transmitting secondary cell information to the third node further includes: receiving, from the third node, an L1 measurement result of a target secondary cell corresponding to a target cell for cell switch and/or identification information of a target secondary cell suggested to be activated; and transmitting secondary cell information of one or more target secondary cells to the third node.

According to embodiments of the present disclosure, the receiving from the third node an L1 measurement result of a target secondary cell corresponding to a target cell for cell switch and/or identification information of a target secondary cell suggested to be activated further includes: after transmitting indication information indicating that the UE successfully accesses a target cell to the third node, receiving from the third node the L1 measurement result of the target secondary cell corresponding to the target cell for cell switch and/or the identification information of the target secondary cell suggested to be activated.

According to embodiments of the present disclosure, the transmitting secondary cell information to the UE further includes: receiving a second L1 measurement report from the UE, wherein the second L1 measurement report includes L1 measurement results of one or more target secondary cells; and transmitting to the UE a secondary cell activation/deactivation media access control (MAC) control element (CE) for indicating an activated state or deactivated state of each of the one or more source secondary cells.

Embodiments of the present disclosure provides a method performed by a third node in a wireless communication system, including: receiving, from a first node, L1 measurement results of one or more candidate secondary cells and/or identification information of a candidate secondary cell suggested to be activated, and/or an L1 measurement result of a target secondary cell corresponding to a target cell for cell switch and/or identification information of a target secondary cell suggested to be activated; and transmitting, to a second node, the L1 measurement result of the one or more candidate secondary cell and/or the identification information of the candidate secondary cell suggested to be activated, and/or the L1 measurement result of the target secondary cell corresponding to the target cell for cell switch and/or the identification information of the target secondary cell suggested to be activated.

According to embodiments of the present disclosure, the method further includes: transmitting, to a first node, load status information from a second node, wherein the load status information includes a load status of each of the one or more candidate secondary cells; and receiving from the first node target secondary cell information, wherein the target secondary cell information is transmitted to the second node through the third node.

According to embodiments of the present disclosure, the method further includes: receiving, from the second node, secondary cell information; and transmitting the secondary cell information to the first node, wherein the secondary cell information includes state information of one or more secondary cells, wherein the state information indicates an activated state or a deactivated state of each of the one or more secondary cells.

According to embodiments of the present disclosure, the one or more secondary cells include one or more candidate secondary cells or one or more target secondary cells.

According to embodiments of the present disclosure, the transmitting to a second node the L1 measurement result of the target secondary cell corresponding to the target cell for cell switch and/or the identification information of the target secondary cell suggested to be activated further includes: after receiving from the second node information indicating that a user equipment (UE) successfully accesses the target cell, transmitting to the second node the L1 measurement result of the target secondary cell corresponding to the target cell for cell switch and/or the identification information of the target secondary cell suggested to be activated.

Embodiments of the present disclosure provide a method performed by a user equipment (UE) in a wireless communication system, including: transmitting, to a first node, a first L1 measurement report, wherein the first L1 measurement report includes L1 measurement results of one or more candidate secondary cells; and receiving secondary cell information from the first node or a second node, wherein the secondary cell information includes state information of one or more secondary cells, wherein the state information indicates an activated state or a deactivated state of each of the one or more secondary cells.

According to embodiments of the present disclosure, the method further includes: transmitting to the first node a third L1 measurement report, wherein the third L1 measurement report includes L1 measurement results of one or more source candidate secondary cells; and receiving from the first node a source secondary cell activation/ deactivation media access control (MAC) control element (CE) for indicating an activated state or deactivated state of each of the one or more source secondary cells.

According to embodiments of the present disclosure, receiving secondary cell information from the first node further includes at least one of the following: receiving a message indicating cell switch from the first node, wherein the message indicating cell switch includes the secondary cell information; receiving a radio resource control (RRC) reconfiguration message from the first node, wherein the RRC reconfiguration message includes the secondary cell information.

According to embodiments of the present disclosure, the message indicating cell switch includes a target cell identifier of a target cell for cell switch and/or secondary cell information of a target secondary cell corresponding to the target cell.

According to embodiments of the present disclosure, the receiving from the second node secondary cell information further includes: transmitting to the second node a second L1 measurement report, wherein the second L1 measurement report includes L1 measurement results of one or more target secondary cells; and receiving from the second node a secondary cell activation/deactivation media access control (MAC) control element (CE) for indicating an activated state or deactivated state of each of the one or more source secondary cells.

According to embodiments of the present disclosure, the method further includes: transmitting a message indicating completion of cell switch to the second node, wherein the second L1 measurement report is included in the message.

According to embodiments of the present disclosure, the first L1 measurement report and/or the second L1 measurement report and/or the third L1 measurement report are transmitted via a media access control (MAC) control element (CE) over a physical uplink shared channel (PUSCH), or via an uplink control information (UCI) over a physical uplink control channel (PUCCH).

Embodiments of the present disclosure provide a user equipment in a wireless communication system, including: a transceiver configured to transmit and receive signals; and a controller coupled to the transceiver and configured to implement the method performed by a user equipment in a wireless communication system according to embodiments of the present disclosure.

Embodiments of the present disclosure provide a node in a wireless communication system, including: a transceiver configured to transmit and receive signals; and a controller coupled to the transceiver and configured to implement the method performed by a node (for example, a first node and/or a second node and/or a third node, or the like) in a wireless communication system according to embodiments of the present disclosure.

Embodiments of the present disclosure provide a computer-readable medium storing computer-readable instructions thereon that, when executed by a processor, implement any method according to embodiments of the present disclosure.

### Advantageous Effects of Invention

The method performed by the first node and/or the second node and/or the third node and/or the user equipment in the wireless communication system provided by embodiments of the present disclosure enables the user equipment (UE) to obtain state information of secondary cells timely, thereby ensuring handover performance, preventing the UE from performing unnecessary operations, and achieving energy saving for the UE.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 is an exemplary system architecture 100 of system architecture evolution (SAE);

FIG. 2 illustrates an example system architecture 200 according to various embodiments of the present disclosure;

FIG. 3 illustrates a schematic diagram of an example method according to an example 1 of the present disclosure;

FIG. 4 illustrates a schematic diagram of an example method according to an example 2 of the present disclosure;

FIG. 5 illustrates a schematic diagram of an example method according to an example 3 of the present disclosure;

FIG. 6 illustrates a schematic diagram of an example method according to an example 4 of the present disclosure;

FIG. 7 illustrates a schematic diagram of an example method according to an example 5 of the present disclosure;

FIG. 8 illustrates a schematic diagram of an example method according to an example 6 of the present disclosure;

FIG. 9 illustrates a schematic diagram of an example method according to an example 7 of the present disclosure;

FIG. 10 illustrates a schematic diagram of an example method according to an example 8 of the present disclosure;

FIG. 11 illustrates a flowchart of a method 1100 performed by a user equipment (UE) in a wireless communication system according to embodiments of the present disclosure;

FIG. 12 illustrates a flowchart of a method 1200 performed by a first node in a wireless communication system according to embodiments of the present disclosure;

FIG. 13a illustrates a flowchart of a method 1300 performed by a second node in a wireless communication system according to embodiments of the present disclosure;

FIG. 13b illustrates a flowchart of a method 1310 performed by a second node in a wireless communication system according to embodiments of the present disclosure;

FIG. 14 illustrates a flowchart of a method 1400 performed by a third node in a wireless communication system according to embodiments of the present disclosure;

FIG. 15 illustrates a schematic diagram of a node 1500 in a wireless communication system according to embodiments of the present disclosure; and

FIG. 16 illustrates a schematic diagram of a user equipment 1600 in a wireless communication system according to embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

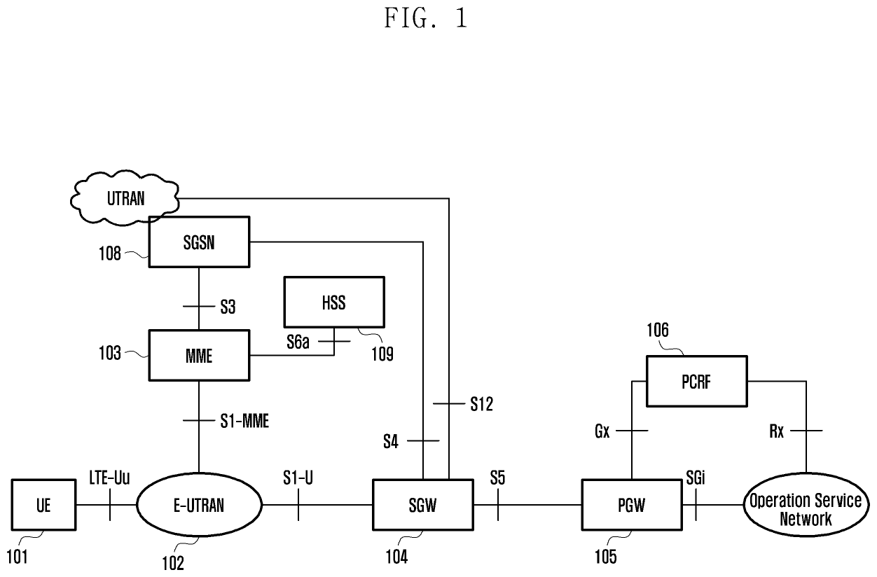

FIGS. 1 to 16 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

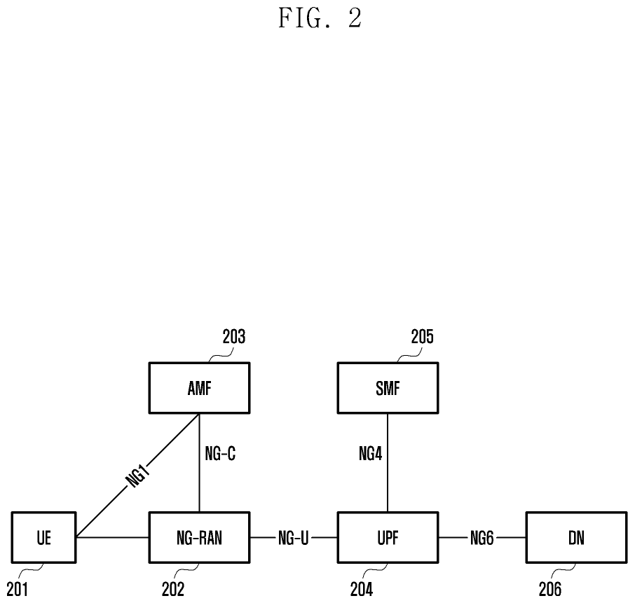

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

Detailed descriptions of steps irrelevant to the present disclosure are omitted herein. In the following embodiments, 5G systems are taken as an example, the access network Central Unit takes a CU as an example and the Distributed Unit takes a DU as an example. The method described is also applicable to corresponding entities of other systems.

In this application, a gNB may be a single base station, or may be a master base station/Master Node (MN) or a secondary base station/Secondary Node (SN) in Dual Connectivity (DC). A group of cells serving a UE in the MN is called a Master Cell Group (MCG), and a group of cells serving the UE in the SN is called a Secondary Cell Group (SCG). A primary cell of the MCG is called a Primary Cell (PCell), and a primary cell of the SCG is called a Primary SCG Cell (PSCell). When the MCG or SCG adopts Carrier Aggregation (CA), other cells other than the PCell and the PSCell are called Secondary Cells (SCells).

In a structure where the Central Unit (CU)/Distributed Unit (DU) is separated, a source cell and a target cell can be located under the same gNB-DU or different gNB-DUs during handover.

The system supports a L1/L2-triggered mobility (LTM) handover mode, also known as layer 1/layer 2 handover (L1/L2 handover, also known as L1/L2 Mobility), or cell switch. A base station or gNB-DU determines a target cell based on a L1 measurement result, and indicates a UE to perform cell switch and access the target cell through a physical layer (L1, Layer 1) control channel (such as PDCCH, Physical Downlink Control Channel) or a MAC layer (L2, Layer 2) MAC CE (MAC Control Element, Media Access Control Control Element) or other methods. The UE accesses to the target cell from a source PCell or a source PSCell according to the cell switch indication or an LTM handover command. The method of cell switch/LTM handover based on a L1 measurement result is also applicable for a dual connectivity (DC) system, in which a SN may independently change a PSCell through the LTM method. That is, the method of cell switch/LTM handover based on a L1 measurement result is applicable for special cells (SpCell) (i.e., PCell and/or PSCell).

In order to support cell switch, the base station or gNB-CU provides LTM configuration information to the UE through a Radio Resource Control (RRC) reconfiguration message before performing cell switch, and the LTM configuration information contains at least an LTM candidate cell set/list and/or LTM candidate cell configuration information and/or L1 measurement configuration information. The UE performs layer 1 measurement (L1 measurement) and transmits an L1 measurement report (also known as L1 measurement reporting) according to the L1 measurement configuration information. The base station or gNB-DU determines whether to perform cell switch based on L1 measurement results provided by the UE, and selects a target cell for the UE from the LTM candidate cells. The LTM candidate cell configuration information contains the cell group configuration information (CellGroupConfig) of the LTM candidate cells. If CA is supported, the cell group configuration information not only contains candidate SpCell information, but also contains candidate SCell information, including the identification and state of a SCell.

When the SCell is in an activated state, the UE needs to perform relevant operations on the SCell, including performing uplink/downlink synchronization, monitoring PDCCHs for the SCell and/or on the SCell, monitoring for obtaining scheduling and/or grant information of the SCell, and performing signaling/service data transmission and channel quality monitoring on the SCell. When the SCell is in an inactive state, the UE does not need to perform relevant operations on the SCell.

In order to reduce the signaling overhead (RRC signaling overhead) on the air interface between the network and the UE, the LTM handover method determines the target cell through L1 measurement results and performs cell change. Meanwhile, after the UE completes the cell change, both the UE and the network continue to save the LTM candidate cell configuration information for subsequent execution of cell change. Therefore, with the mobility of the UE, the candidate SCell and its state may also change. The change of the SCell state may be affected by factors such as cell load and current cell quality, etc. Therefore, when an LTM handover is triggered, if the UE cannot obtain information of SCells in the activated state in time, it may have an impact on the service transmission during the handover. If the UE cannot obtain information of SCells in the inactive state in time, the UE may perform unnecessary processing, including performing PDCCH detection and blind detection for SCell resource scheduling, which is not conducive to energy saving of the UE.

In a L3 handover mode, selection of a target cell (target PCell or target PSCell) is based on L3 measurement results. Moreover, selection of a target SCell and state (activated and deactivated) thereof are based on L3 measurement results and/or service state and/or cell load status.

In an LTM handover mode, selection of a target cell (target PCell or target PSCell) is based on the L1 measurement results, and the selection of SCell state has not yet been determined. Therefore, the present disclosure proposes a method for determining SCell state selection in an LTM handover mode, and a method for indicating the state of a target SCell during an LTM handover, thereby enabling the UE to obtain the SCell state timely in the LTM handover mode. Particularly, when the UE performs cell change of the PCell or PSCell and accesses the target cell, if it can obtain the SCell and its state information on the target side in time, it will ensure the LTM handover performance, that is, the service data transmission performance during handover, and avoid the UE from performing unnecessary operations, thus achieving energy saving on the UE.

During cell change, if the network determines a target cell (target PCell or target PSCell) based on the measurement results, then the SCell in the cell group configuration information (CellGroupConfig) of the target cell is referred to as a target SCell, and the target SCell may also be referred to as a target SCell corresponding to the target cell. The SCell in the cell group configuration information of the source cell (source PCell or source PSCell) is referred to as a source SCell, and the source SCell may also be referred to as a source SCell corresponding to the source cell (source PCell or source PSCell). The SCell in the cell group configuration information of a candidate cell (candidate PCell or candidate PSCell) is referred to as a candidate SCell, and the candidate SCell may also be referred to as a candidate SCell corresponding to the candidate cell.

To simplify the description, a source SCell is used to refer to one or more source SCells, and a target SCell is used to refer to one or more target SCells.

The cell switch/LTM handover method based on the L1 measurement results is also applicable to dual connectivity (DC) systems. Therefore, methods described in the present disclosure are applicable to the state indication of the SCell by the MN in the LTM handover mode, and is also applicable to the state indication of the SCell by the SN in the LTM handover mode. The source gNB-DU, candidate gNB-DU, target gNB-DU, and gNB-CU in the present disclosure may be located in a base station of a single connectivity system, or located in an MN or SN of a dual connectivity system. The above-mentioned LTM candidate cell is a candidate cell used for LTM handover, and may be an LTM candidate cell for the PCell or an LTM candidate cell for the PSCell.

The candidate cell in the present disclosure may also be referred to as a target candidate cell, or a candidate target cell, which is a candidate special cell (candidate SpCell, candidate PCell or candidate PSCell). The candidate SCell may also be referred to as a target candidate SCell or a target candidate SCell.

In the present application, the message names are just examples, and the messages may be named with other names. The sequence numbers of messages do not represent the order in which the messages are executed, but only represent the names of messages, which are used to distinguish the messages.

The present disclosure respectively provides a method for state indication of a source SCell and a method for state indication of a target SCell when an LTM handover mode is configured.

Example 1 shows a method of state indication of a source SCell.

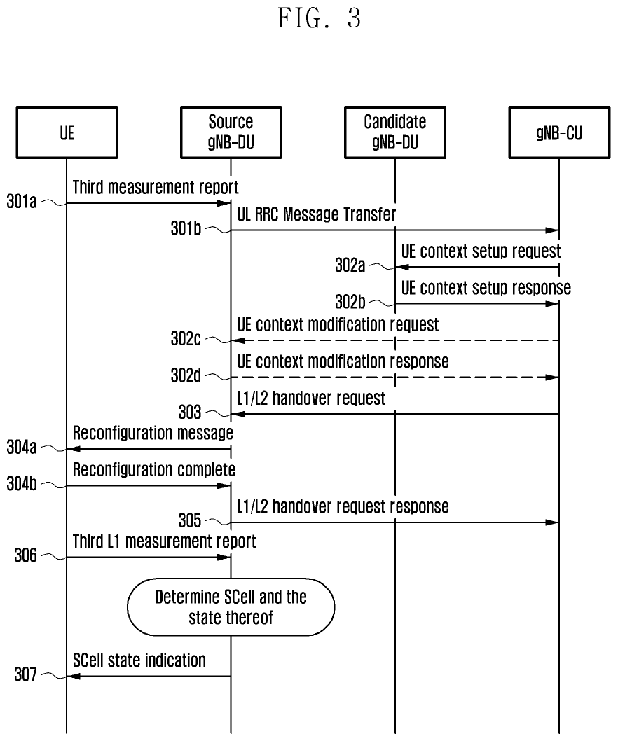

A source gNB-DU determines an SCell(s) in an MCG or a SCG that needs to be activated or deactivated based on an L1 measurement result reported by a UE. The specific process is shown in FIG. 3. The source gNB-DU determines states of configured SCell(s) based on the L1 measurement result and selects an appropriate SCell for the UE for service transmission, thus avoiding the signaling overhead and transmission delay caused by SCell change by transmitting an L3 measurement report and RRC reconfiguration.

FIG. 3 illustrates a schematic diagram of an example method according to an example 1 of the present disclosure.

In step 301a, the UE transmits a third measurement report (MeasurementReport) to the source gNB-DU, which contains a L3 measurement result of a neighboring cell.

In step 301b, the source gNB-DU transmits an uplink RRC message transfer (UL RRC MESSAGE TRANSFER) message to the gNB-CU, which contains the L3 measurement report (MeasurementReport) received from the UE.

The gNB-CU determines whether to use the LTM handover mode based on the L3 measurement report. If the LTM handover mode configuration is to be used, the gNB-CU selects (or prepares) candidate cells for the UE for LTM handover based on the L3 measurement report.

In step 302a, the gNB-CU transmits a UE context setup request (UE CONTEXT SETUP REQUEST) message to the candidate gNB-DU. The message contains at least one of the following:
LTM handover indication information, indicating that an LTM handover mode is used to perform cell change for the UE, and indicating the candidate gNB-DU to configure resources for the LTM handover of the UE;
Candidate cell information, information of candidate cells for LTM selected by a gNB-CU for the UE. The candidate cell information at least includes identifiers of one or more candidate cells, and the identifiers may be a CGI or other cell identifiers.
Information of a list of candidate SCells to be setup (SCell to be setup list). If CA is supported, gNB-CU selects candidate SCells for the UE based on the L3 measurement results. The candidate SCell information contains at least one of the following information:
   one or more SCell identifiers, which may be a cell global ID (CGI) or other cell identifiers.
   the cell index of one or more SCells. The index may be a SCellIndex.
Value range of the group ID. The value range is (n1, n2), where n1 and n2 are natural numbers, and n1 and n2 are the minimum and maximum values of the group ID respectively. The value range of the group ID assigned to each gNB-DU is different. The group ID is used to indicate the group to which a cell belongs, or is called a synchronization group or TA (Timing Advance) group. Herein, the group ID is used for the group to which the cell belongs, and the UE has the same downlink synchronization and uplink synchronization relationship with the cells in the same group, which means that if the UE is uplink and downlink synchronized with one of the cells in the same group, it will also be uplink and downlink synchronized with the other cells in the group. Each group corresponds to a TA value (or TA amount) and a time alignment timer TAT (timeAlignmentTimer). That is to say, the UE uses the same TA value for uplink transmission with all cells in the group, and uses the TAT to determine whether the TA value of the group is valid. If the TAT does not expire, it means that the TA value is valid and the UE is uplink synchronized with all cells in the group. Otherwise, it means that the TA value is invalid and the UE is no longer uplink synchronized with all cells in the group. Herein, cells configured for the UE, including the source/target/candidate PCell, source/target/candidate PSCell, and source/ target/candidate SCell, all have a group ID. Herein, the source PCell and/or the target PCell and/or the candidate PCell and/or the source PSCell and/or the target PSCell and/or the candidate PSCell and/or the source SCell and/or the target SCell and/or the candidate SCell may belong to the same group. For example, if the UE's target PCell and the source PCell or source SCell belong to the same group, then the UE obtains a valid TA value of the target PCell, that is, the UE and the target PCell are uplink synchronized. The UE obtains an initial value of the TA through random access or other methods, and the network adjusts the TA value based on uplink reception. The UE performs uplink transmission or TA adjustment, etc. In an LTM mode, if the UE does not stop the TAT timer after accessing a target cell through LTM, and if the TAT expires, the TA value corresponding to the group is considered to be invalid. The cases in which TAT starts or restarts include the following:
   The UE receives a timing advance command (TAC) MAC CE.
   Alternatively, the UE obtains the TAC through a random access response message, and the TAC is for a certain cell in the group.
   Alternatively, the UE obtains the TAC of SpCell from MSGB.

In step 302b, the candidate gNB-DU transmits a UE context setup response (UE CONTEXT SETUP RESPONSE) message to the gNB-CU. If the candidate gNB-DU supports LTM handover, the message contains at least one of the following information:
accepted candidate cell information: it includes identifiers of one or more candidate cells, which may be a cell global ID (CGI) or other cell identifiers. The candidate gNB-DU finally determines candidate cells acceptable for LTM handover from the candidate cells obtained in 302a.
Information of a list of SCells that failed to setup (SCell Failed To Setup List), which includes one or more SCell identifiers, which may be a cell global ID (CGI) or other cell identifiers.
Candidate cell group configuration information (CellGroupConfig), which contains cell group configuration information of one or more candidate cells. The candidate cell group configuration information is included in RRC information transmitted by the DU to the CU (DU To CU RRC Information). The candidate cell group configuration information includes candidate cell information and/or one or more candidate SCell information. Herein, it contains at least one of the following information:
   Candidate cell information, which includes at least one of the following information:
      The identifier of a candidate cell, which may be a cell global ID (CGI) or another cell identifier.
      The group ID to which the candidate cell belongs, which indicates the group to which the candidate cell belongs. Candidate cells in the same group have the same downlink synchronization and uplink synchronization relationship with the UE.
      The candidate cell index CandidateCellIndex, which indicates the index of the candidate cell in the list of all candidate cells. The value range is (0 to maxCandidateCells−1), where maxCandidateCells refers to the maximum number of candidate cells configured for the UE.
      Dedicated preamble. Each candidate cell assigns a dedicated preamble to the UE for random access, which can reduce the time for the UE and the candidate cell to complete uplink synchronization. If the network transmits the dedicated preamble to the UE when the L1/L2 handover is triggered, then the gNB-DU includes the received dedicated preamble in the synchronization indication information and transmits it to the UE. If the network transmits the dedicated preamble to the UE directly, the dedicated preamble is included in an RRC reconfiguration message transmitted to the UE.
      The UE's identifier in the candidate cell, which may be a C-RNTI or other user identity information.
   Candidate SCell information, which contains at least one of the following information:
      The identifier of a candidate SCell, which may be a cell global ID (CGI) or another cell identifier;
      The cell index of the candidate SCell. The index may be a SCellIndex.
      The state of the candidate SCell, which may be an activated state or a de-activated state. The initial configuration for the state of the candidate SCell is performed in this process.
      The group ID of the candidate SCell, which indicates the group to which the candidate SCell belongs, where cells in the same group have the same downlink synchronization and uplink synchronization relationship with the UE.

If the candidate cell is located at the source gNB-DU, then steps 302c and 302d need to be performed to obtain information required for LTM handover, such as the candidate cell group configuration information. The message used in step 302c is a UE context modification request message, or another message. The information contained in the message is the same as that in step 302a, which will not be described again here. The message used in step 302d is a UE context modification response message, or another message. The information contained in the message is the same as that in step 302b, and will not be described again here.

In step 303, gNB-CU transmits an L1/L2 handover request message to the source gNB-DU, indicating that LTM handover is triggered for the UE, that is, indicating that the gNB-DU changes the SpCell of the UE using a L1/L2 handover mode. The message contains at least one of the following information:
(1) L1/L2 handover indication, which indicates that the gNB-DU changes the source PCell or source PSCell of the UE to the target cell using a L1/L2 handover mode.
(2) Candidate cell group configuration information, which contains configuration information of one or more candidate cell groups. The candidate cell group configuration information contains at least one of the following:
   Candidate cell identifier, which may be a cell global ID (CGI), or a physical cell ID (PCI).
   The group ID to which the candidate cell belongs, which indicates the group to which the candidate cell belongs. Candidate cells in the same group have the same downlink synchronization and uplink synchronization relationship with the UE.
   The candidate cell index CandidateCellIndex, which indicates the index of the candidate cell in the list of all candidate cells. The value range is (0 to maxCandidateCells−1), where maxCandidateCells refers to the maximum number of candidate cells configured for the UE.
   Dedicated preamble. Each candidate cell assigns a dedicated preamble to the UE for random access, which can reduce the time for the UE and the candidate cell to complete uplink synchronization. If the network transmits the dedicated preamble to the UE when the L1/L2 handover is triggered, then the gNB-DU includes the received dedicated preamble in the synchronization indication information and transmits it to the UE. If the network transmits the dedicated preamble to the UE directly, the dedicated preamble is included in an RRC reconfiguration message transmitted to the UE.
   Candidate SCell information, which contains at least one of the following information:
      1) The identifier of a candidate SCell, which may be a cell global ID (CGI) or another cell identifier;
      2) The cell index of the candidate SCell. The index may be a SCellIndex.
      3) The state of the candidate SCell, which may be an activated state or a de-activated state. The initial configuration for the state of the candidate SCell is performed in this process.
      4) The group ID of the candidate SCell, which indicates the group to which the candidate SCell belongs, where cells in the same group have the same downlink synchronization and uplink synchronization relationship with the UE.
(3) RRC reconfiguration message transmitted to the UE, which is included in the L1/L2 handover request message in the form of an RRC container. It contains:
   Candidate cell group configuration information (CellGroupConfig), which contains cell group configuration information of one or more candidate cells. See step 302b for details of the configuration information of the cell group, which will not be described again here.
   Timer T, which is used to determine whether the L1/L2 handover of the UE is successful during the L1/L2 handover process. When the UE receives a L1/L2 handover command and completes configuration of a target cell, it starts the timer T and starts monitoring a PDCCH in the target cell. If the UE has not detected a PDCCH transmitted to itself by the target cell when the timer T expires, then the L1/L2 handover is considered to be failure, and the UE performs cell selection and selects a suitable cell to access. Through the setting of timer T, it is guaranteed that when the UE cannot access the target cell, it can also select a suitable cell to access in time, thereby reducing impact on the service quality of the UE due to the failure of L1/L2 handover.
   Measurement configuration information, including at least one of the following:
   L1/L2 handover measurement configuration information; and
   L3 handover measurement configuration information.
(4) Measurement configuration information, including the L1/L2 handover measurement configuration information.

The L1/L2 handover request message may be a UE context modification request (UE CONTEXT MODIFICATION REQUEST) message, or a DL RRC message transfer (DL RRC MESSAGE TRANSFER) message, or other messages.

In step 304a, the source gNB-DU transmits a RRC reconfiguration message (RRCReconfiguration) to the UE, which contains configuration information of the candidate cells. The reconfiguration message is transmitted to the source gNB-DU by the gNB-CU in the form of a RRC container, and is transmitted to the UE by the source gNB-DU. Refer to step 303 for details of this message, which will not be described again here.

In step 304b, the UE transmits a reconfiguration complete message (RRCReconfiguration Complete) to the source gNB-DU. It indicates that the configuration of the LTM candidate cell is completed.

In step 305, the source gNB-DU transmits a L1/L2 handover request response message to the gNB-CU, which indicates that the source gNB-DU accepts the L1/L2 handover request and/or the UE has completed the configuration of the LTM candidate cell.

The message may be a UE context modification response (UE CONTEXT MODIFICATION RESPONSE) message, or a UL RRC message transfer (UL RRC MESSAGE TRANSFER) message, or other messages.

In step 306, the UE transmits a third L1 measurement report to the source gNB-DU, and provides a link quality of the candidate cell for the L1/L2 handover and/or source SCell cell to the source gNB-DU. If carrier aggregation is supported and the SCell is configured, the source gNB-DU determines whether the state of the source SCell needs to be adjusted based on the L1 measurement result. If the SCell state needs to be adjusted, the SCell state indication information is transmitted to the UE.

The third L1 measurement report is transmitted through a PUSCH channel, such as in the form of a MAC CE or other forms; or transmitted through a PUCCH channel, such as in the form of uplink control information (UCI).

In step 307, the source gNB-DU transmits the SCell state indication information to the UE, indicating the state of the source SCell, which is an activated state or a de-activated state. The SCell state indication information is transmitted by a SCell activation/deactivation MAC CE.

The link quality and/or load status etc. of the candidate SCell changes with the movement of the UE, resulting in changes in the states of the candidate SCells. The present disclosure proposes several methods for indicating the state of a candidate SCell, enabling the UE to get the state of the candidate SCell in time, thereby achieving transmitting service data by using an activated SCell during handover, and ensuring service transmission performance during handover. In addition, it may also avoid unnecessary processing on deactivated SCells of the UE. For example, it is not necessary to monitor the PDCCH used for the SCell and/or monitor the PDCCH on the SCell, thereby achieving the energy saving of the UE. Example 2 to example 8 provide several methods for indicating state of the target SCell during LTM handover.

Example 2 shows a method for indicating the state of a target SCell by a source cell during LTM handover.

In example 2, before the source gNB-DU triggers LTM handover, the candidate gNB-DU determines the candidate SCell and the state thereof, and transmits information of the candidate SCell to the source gNB-DU through the gNB-CU. When the source gNB-DU decides to trigger an LTM handover, it transmits a cell switch message or information to the UE, while transmitting the target PCell identifier or PSCell identifier and the target SCell information corresponding to the target PCell or PSCell to the UE. During cell switch, the UE obtains state of the target SCell in time, thereby ensuring handover performance. The UE may also avoid performing un-necessary operations according to the SCell state, thereby achieving energy saving for the UE.

Herein, the candidate gNB-DU determines the candidate SCell and the state thereof based on the received L1 measurement result of the candidate SCell or identification information of the candidate SCell, in combination with the current load conditions of the cell and the current service state of the UE. The L1 measurement result of the candidate SCell or the identification information of the candidate SCell is transmitted to the gNB-CU through the source gNB-DU and forwarded to the candidate gNB-DU. The current service state of the UE is provided by the gNB-CU to the candidate gNB-DU.

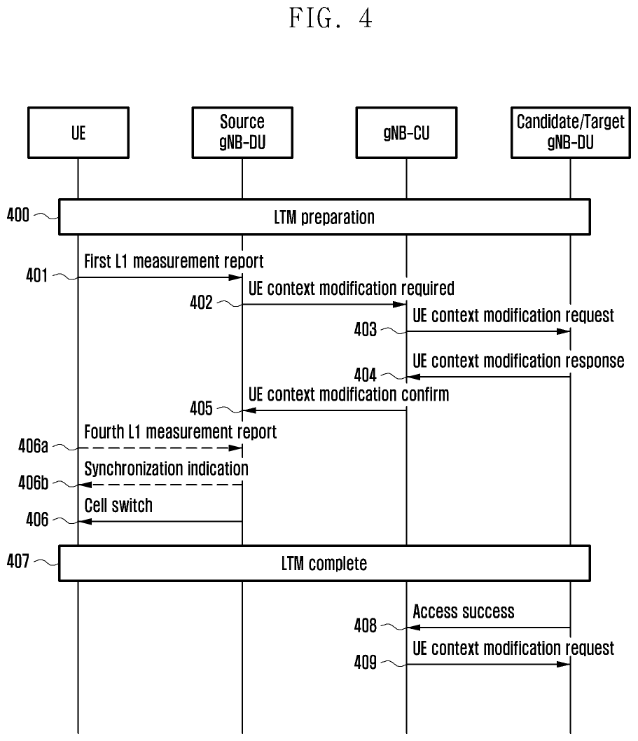

The specific process is shown in FIG. 4. FIG. 4 illustrates a schematic diagram of an example method according to an example 2 of the present disclosure.

In step 400, LTM preparation is conducted, and configuration of LTM candidate cells is completed. Refer to steps 301a-305 for the specific process, which will not be described again here.

In step 401, the UE transmits a first L1 measurement report to a source gNB-DU, providing a first L1 measurement result, including at least one of the following:
L1 measurement results of one or more candidate cells, including at least one of the following:
   The identifier of a candidate cell, which may be a cell global ID (CGI) or another cell identifier.
   Measurement value of the candidate cell, for example, a RSRP value. The RSRP may be SSB RSRP, or CSI RSRP, or a RSRP value of other signals.
   L1 measurement results of one or more candidate SCell, including at least one of the following:
      The identifier of a candidate SCell, which may be a global cell ID (CGI), an SCell index (SCellIndex), or other cell identifiers.
      Measurement value of the candidate SCell, for example, a RSRP value. The RSRP may be SSB RSRP, or CSI RSRP, or a RSRP value of other signals.

The first L1 measurement report is transmitted through a PUSCH channel, such as in the form of a MAC CE or other forms; or transmitted through a PUCCH channel, such as in the form of uplink control information (UCI).

The source gNB-DU may select one or more SCells as candidate SCells suggested to be activated based on the L1 measurement results of the candidate SCells, based on the cell quality or by using other methods. Therefore, the source gNB-DU may transmit the L1 measurement results of the candidate SCells to the gNB-CU, or transmit the identification information of the candidate SCells suggested to be activated to the gNB-CU.

In step 402, the source gNB-DU transmits a UE context modification required (UE CONTEXT MODIFICATION REQUIRED) message to the gNB-CU. The source gNB-DU forwards the L1 measurement result received in step 401 to the gNB-CU, and/or determines the candidate SCells suggested to be activated based on the L1 measurement result, and transmits the identification information of the candidate SCells suggested to be activated to the gNB-CU. The message contains at least one of the following information:
L1 measurement results of one or more candidate cells, see step 401 for details, which will not be described again here.
Identification information of a candidate SCell corresponding to one or more candidate cells, which includes at least one of the following:
   The identifier of the candidate cell, which may be a cell global ID (CGI) or another cell identifier.
   The identification information of the candidate SCells suggested to be activated, which includes the cell identifier of one or more candidate SCells. The cell identifier may be a global cell ID (CGI), an SCell index (SCellIndex), or other cell identifiers.

In step 403, the gNB-CU transmits a UE context modification request (UE CONTEXT MODIFICATION REQUEST) message to the candidate gNB-DU. The gNB-CU transmits the UE context modification request message to the candidate gNB-DU where the candidate SCell is located based on the L1 measurement result or the identification information of the candidate SCells suggested to be activated received in step 402. The message contains at least one of the following information:
Measurement result of one or more candidate SCells, including at least one of the following:
   The identifier of a candidate SCell, which may be a global cell ID (CGI), an SCell index (SCellIndex), or other cell identifiers.
   Measurement value of the candidate SCell, for example, a RSRP value. The RSRP may be SSB RSRP, or CSI RSRP, or a RSRP value of other signals.
The identification information of the candidate SCells suggested to be activated. The gNB-CU transmits the identification information of the candidate SCells suggested to be activated received in step 402 to the candidate gNB-DU. The identification information includes the cell identifier of one or more candidate SCells. The cell identifier may be a global cell ID (CGI), an SCell index (SCellIndex), or other cell identifiers.
Service state of the UE. If the SRB and/or DRB established by the UE on the SCell changes, the service state of the UE needs to be included and the updated SRB and/or DRB information needs to be provided to the candidate gNB-DU. The changes include update of the SRB/DRB information or deletion of the SRB/DRB.

The candidate gNB-DU finally determines the state of a candidate SCell based on the obtained measurement result of the candidate SCell or the identification information of the candidate SCells suggested to be activated, in combination with the UE service state and/or the load status of the cell, that is, determining whether the state of the candidate SCell is an activated state or a deactivated state, and transmits the candidate SCell information to the gNB-CU in step 404.

In step 404, the candidate gNB-DU transmits a UE context modification response (UE CONTEXT MODIFICATION RESPONSE) message to the gNB-CU, and transmits the candidate SCell information corresponding to the candidate cell to the gNB-CU. The SCell information contains at least one of the following:
The identifier of the candidate cell, which may be a cell global ID (CGI) or another cell identifier.
The identifier of one or more SCells, which may be a global cell ID (CGI), an SCell index (SCellIndex), or other cell identifiers.
The state of one or more SCells, which may include an activated state or a de-activated state.

In step 405, the gNB-CU transmits a UE context modification confirm (UE CONTEXT MODIFICATION CONFIRM) message or a DL RRC message transfer (DL RRC MESSAGE TRANSFER) message or a UE context modification request (UE CONTEXT MODIFICATION REQUEST) message to the source gNB-DU, and transmits the candidate SCell information obtained in step 404 to the source gNB-DU.

If step 401 does not contain the measurement value of the candidate cell, then step 406a is performed.

In step 406a, the UE transmits a fourth L1 measurement report to the source gNB-DU. The fourth L1 measurement report contains L1 measurement results of one or more candidate cells. The L1 measurement results contain at least one of the following:
The identifier of the candidate cell, which may be a cell global ID (CGI) or another cell identifier.
Measurement value of the candidate cell, for example, a RSRP value. The RSRP may be SSB RSRP, or CSI RSRP, or a RSRP value of other signals.

In step 406b, the source gNB-DU transmits synchronization indication information or message to the UE.

The target cell or candidate cell or target SCell or candidate SCell belongs to the source gNB-DU. The source gNB-DU may determine whether the TA value of the group to which the cell belongs is valid for the UE according to the group to which the cell belongs. If the TA value is invalid or the cell group does not have a TA value or the cell does not belong to the source gNB-DU, then the source gNB-DU performs step 406b to indicate the UE to synchronize with the target cell and/or target SCell, or indicate the UE to synchronize with the candidate cell and/or candidate SCell to obtain the TA value of the cell.

The synchronization indication information or message may be in the form of DCI or MAC CE. The synchronization indication information at least contains at least one of the following:
Cell identification information, which includes identifier of one or more cells and indicates identifier of the cell that the UE needs to synchronize with. It may be a CGI or other identifiers.

The UE determines the group to which the cell belongs based on the cell identifier, thereby determining whether there is a valid TA value. If there is no valid TA value, the UE needs to obtain a valid TA value, either through a random access process or other methods.

In step 406, the source gNB-DU transmits a cell switch message or information to the UE, indicating the UE to perform cell switch and hand over to a target cell. The source gNB-DU determines the target cell based on the L1 measurement result obtained in step 401 or 406a. When the source gNB-DU selects a target cell for the UE from the candidate cells, the target SCell corresponding to the target cell may be determined. The source gNB-DU determines the target SCell information based on the candidate SCell information obtained in step 405. Therefore, the cell switch message or information may also include the target SCell identifier and/or the target SCell state. The message contains at least one of the following information:

The target cell identifier, which may be a candidate cell index CandidateCellIndex or a global cell ID (CGI). The candidate cell index CandidateCellIndex indicates the index of the candidate cell in the list of all candidate cells. The value range is (0 to maxCandidateCells−1), where maxCandidateCells refers to the maximum number of candidate cells configured for the UE.
Target SCell information, which includes at least one of the following:
   The identifier of one or more SCells, which may be a global cell ID (CGI), an SCell index (SCellIndex), or other cell identifiers.
   The state of one or more SCells, which may include an activated state or a de-activated state.

In step 407, the UE accesses the target cell and indicates successful completion of cell switch.

In this step, the UE transmits a cell switch complete message or information, or transmits an LTM handover complete message or information to indicate that the UE has completed cell switch (or indicates that the UE has completed LTM handover), and accesses the target cell. The cell switch complete message may be transmitted through a physical uplink control channel (PUCCH) or a physical uplink shared channel (PUSCH) or other uplink channels or uplink signals. If it is transmitted through a physical uplink shared channel (PUSCH), it may be in the form of a media access control (MAC) control element (CE) or in another form, while if it is transmitted through a physical uplink control channel (PUCCH), it may be in the form of uplink control information (UCI) (for example, transmitting a scheduling request (SR)).

When the UE accesses the target cell, the UE determines the operations that need to be performed based on the state of the target SCell. For the activated SCell, the UE performs related operations, such as monitoring the PDCCH for the SCell and/or monitoring the PDCCH on the SCell, and detecting for obtaining the scheduling/grant information of the SCell. The target gNB-DU performs related operations according to the SCell state, such as providing scheduling and/or grant information of the activated SCell to the UE through the PDCCH, for service transmission. The UE obtains the TA value of the target SCell through the target SCell identifier obtained in step 406 and information on the cell group to which the target SCell belongs, or performs a synchronization process according to the indication in step 406b to obtain the TA value of the target SCell. In this way, the UE may obtain the TA value of the target SCell in time before performing cell switch, enabling the target side to schedule for the target SCell of the UE timely, thereby improving handover performance.

In step 408, the target gNB-DU transmits an access success (ACCESS SUCCESS) message to the gNB-CU, indicating that the UE successfully accesses the target cell. The access success message at least includes the target cell identifier.

In step 409, the gNB-CU transmits a UE context modification request (UE CONTEXT MODIFICATION REQUEST) message to the target gNB-DU. It transmits LTM handover configuration related information to the target gNB-DU. The modification request message includes at least one of the following. For specific description and content of the information, see step 303, which will not be described again here.
(1) L1/L2 handover indication;
(2) Candidate cell group configuration information;
(3) Measurement configuration information.

Example 3 shows another method for indicating the state of a target SCell by a source cell during LTM handover.

In example 3, when a source gNB-DU prepares to trigger LTM handover, it indicates a target gNB-DU to determine a candidate SCell and the state thereof, and transmits information of the candidate SCell to the source gNB-DU through a gNB-CU. When the source gNB-DU transmits a cell switch message or information to the UE, it also transmits the target PCell identifier or PSCell identifier and the target SCell information corresponding to the target PCell or PSCell to the UE. During the cell switch, the UE obtains state of the target SCell in time, thereby ensuring handover performance. The UE may also avoid performing unnecessary operations according to the SCell state, thereby achieving energy saving for the UE.

The target gNB-DU determines a target SCell and the state thereof based on the received measurement result of the target SCell or identification information of the target SCell, in combination with the current load status of the cell and/or the current service state of the UE. The measurement result of the target SCell or the identification information of the target SCell is transmitted to the gNB-CU through the source gNB-DU and forwarded to the candidate gNB-DU. The current service state of the UE is provided by the gNB-CU to the target gNB-DU.

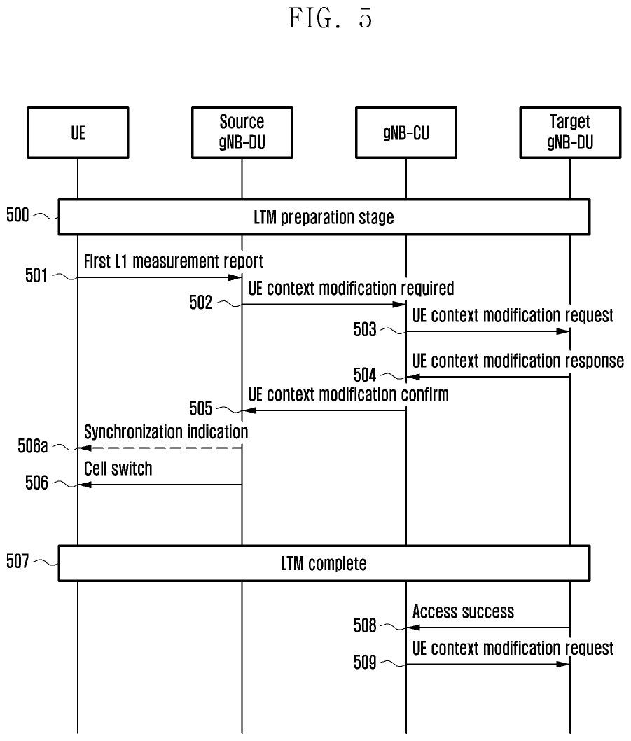

The specific process is shown in FIG. 5. FIG. 5 illustrates a schematic diagram of an example method according to an example 3 of the present disclosure.

In step 500, LTM preparation is conducted, and configuration of an LTM candidate cell is completed. Refer to steps 301a-305 for the specific process, which will not be described again here.

In step 501, the UE transmits a first L1 measurement report to a source gNB-DU, providing a first L1 measurement result. The first L1 measurement result includes the same content as described in step 401, which will not be described again here.

The source gNB-DU determines the target PCell or target PSCell based on the received L1 measurement result, and determines the corresponding target SCell based on the target PCell or target PSCell. It also selects one or more SCells from the target SCells as the target SCell suggested to be activated according to the L1 measurement result of the SCell, based on the cell quality or by using other methods. Therefore, the source gNB-DU may transmit the L1 measurement result of the target SCell to the gNB-CU, or transmit the identification information of the target SCell suggested to be activated to the gNB-CU.

In step 502, the source gNB-DU transmits a UE context modification required (UE CONTEXT MODIFICATION REQUIRED) message to the gNB-CU. The source gNB-DU forwards the L1 measurement result of the target SCell received in step 501 to the gNB-CU, and/or determines the activated target SCell based on the L1 measurement result, and transmits the identification information of the target SCell suggested to be activated to the gNB-CU. The message contains at least one of the following information:

Identifier of the target cell, identifier of the target cell selected by the source gNB-DU, identifier of the target PCell or target PSCell, where the identifier may be a global cell ID (CGI) or other cell identifiers.
L1 measurement result, including at least one of the following:
   L1 measurement result of the target SCell, including at least one of the following:
      The identifier of one or more target SCells, which may be a global cell ID (CGI), an SCell index (SCellIndex), or other cell identifiers.
      Measurement value of one or more target SCells, for example, a RSRP value. The RSRP may be SSB RSRP, or CSI RSRP, or a RSRP value of other signals.
The identification information of the target SCell suggested to be activated, which includes the cell identifier of one or more target SCells. The cell identifier may be a global cell ID (CGI), an SCell index (SCellIndex), or other cell identifiers.

In step 503, the gNB-CU transmits a UE context modification request (UE CONTEXT MODIFICATION REQUEST) message to the target gNB-DU. The gNB-CU determines the target gNB-DU where the target SCell is located based on the target cell identifier or target SCell identification information obtained in step 502, and transmits the UE context modification request message to the target gNB-DU. The message contains at least one of the following information:
Measurement result of the target SCell. The gNB-CU transmits the L1 measurement result of the target SCell received in step 502 to the target gNB-DU. The content of the measurement result of the target SCell is shown in step 502, which will not be described again here.
The identification information of the target SCell suggested to be activated. The gNB-CU transmits the identification information of the target SCell suggested to be activated received in step 502 to the target gNB-DU. The content of the identification information of the target SCell suggested to be activated is shown in step 502, which will not be described again here.
Service state of the UE. If the SRB and/or DRB established by the UE on the SCell changes, the service state of the UE needs to be included and the updated SRB and/or DRB information needs to be provided to the target gNB-DU. The changes include update of the SRB/DRB information or deletion of the SRB/DRB.

The target gNB-DU determines the state of the target SCell based on the obtained measurement result of the target SCell or the identification information of the target SCell suggested to be activated in combination with the UE service state and/or the load status of the cell, and transmits the target SCell information to the gNB-CU in step 504.

In step 504, the target gNB-DU transmits a UE context modification response (UE CONTEXT MODIFICATION RESPONSE) message to the gNB-CU, and transmits the target SCell information to the gNB-CU. The SCell information contains at least one of the following:
The identifier of one or more SCells, which may be a global cell ID (CGI), an SCell index (SCellIndex), or other cell identifiers.
The state of one or more SCells, which may include an activated state or a de-activated state.

In step 505, the gNB-CU transmits a UE context modification confirm (UE CONTEXT MODIFICATION CONFIRM) message or a DL RRC message transfer (DL RRC MESSAGE TRANSFER) message or a UE context modification request (UE CONTEXT MODIFICATION REQUEST) message to the source gNB-DU, and transmits the target SCell information obtained in step 504 to the source gNB-DU.

In step 506a, the source gNB-DU transmits synchronization indication information or message to the UE. It is similar to that described in 406b, and will not be described again here.

In step 506, the source gNB-DU transmits a cell switch message or information to the UE, indicating the UE to perform cell switch and hand over to a target cell. The message contains at least one of the following information:
The target cell identifier, which may be a candidate cell index CandidateCellIndex or a global cell ID (CGI). The candidate cell index CandidateCellIndex indicates the index of the candidate cell in the list of all candidate cells. The value range is (0 to maxCandidateCells−1), where maxCandidateCells refers to the maximum number of candidate cells configured for the UE.
Target SCell information, which includes at least one of the following:
   The identifier of one or more SCells, which may be a global cell ID (CGI), an SCell index (SCellIndex), or other cell identifiers.
   The state of one or more SCells, which may include an activated state or a de-activated state.

In step 507, the UE accesses the target cell and indicates successful completion of cell switch.

In this step, the UE transmits a cell switch complete message or information, or transmits an LTM handover complete message or information to indicate that the UE has completed cell switch (or indicates that the UE has completed LTM handover), and accesses the target cell. The method for transmitting the cell switch complete message is shown in step 407, which will not be described again here.

When the UE accesses the target cell, the UE determines the operations that need to be performed based on the state of the target SCell. For the activated SCell, the UE performs related operations, such as monitoring the PDCCH for the SCell and/or monitoring the PDCCH on the SCell, and detecting for obtaining the scheduling/grant information of the SCell. The target gNB-DU performs related operations according to the SCell state, such as providing scheduling and/or grant information of the activated SCell to the UE through the PDCCH, for service transmission. The UE obtains the TA value of the target SCell through the target SCell identifier obtained in step 506 and information on the cell group to which the target SCell belongs, or performs a synchronization process according to the indication in step 506b to obtain the TA value of the target SCell. In this way, the UE may obtain the TA value of the target SCell in time before performing cell switch, enabling the target side to schedule for the target SCell of the UE timely, thereby improving handover performance.

The steps 508 and 509 are similar to steps 408 and 409, which will not be described again here.

Example 4 shows another method for indicating the state of a target SCell by a source cell during LTM handover.

In example 4, before the source gNB-DU triggers LTM handover, the candidate gNB-DU determines a candidate SCell and the state thereof, and transmits information of the candidate SCell through an RRC reconfiguration message to the UE via the gNB-CU. When the UE receives the cell switch message or information transmitted by the source gNB-DU, the UE determines operations that need to be performed based on the SCell state provided in the cell group configuration information of the target cell in the RRC reconfiguration message (that is, the state of the target SCell corresponding to the target cell). For the activated SCell, the UE performs related operations, such as monitoring the PDCCH for the SCell and/or monitoring the PDCCH on the SCell, and detecting for obtaining the scheduling/grant information of the SCell.

The candidate gNB-DU determines a candidate SCell and the state thereof based on the received L1 measurement result of the candidate SCell or identification information of the candidate SCell, in combination with the current load status of the cell and/or the current service state of the UE. The L1 measurement result of the candidate SCell or the identification information of the candidate SCell is transmitted to the gNB-CU through the source gNB-DU and forwarded to the candidate gNB-DU. The current service state of the UE is provided by the gNB-CU to the candidate gNB-DU.

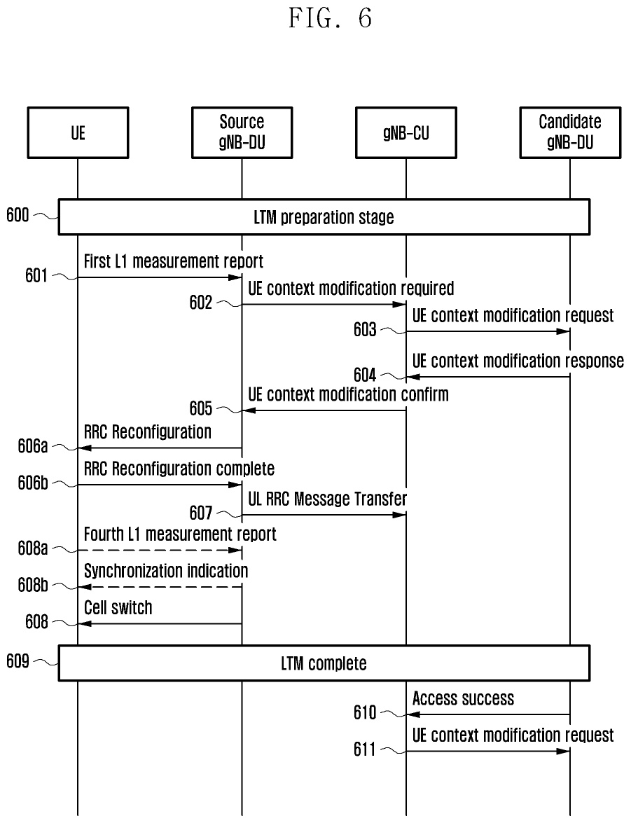

The specific process is shown in FIG. 6. FIG. 6 illustrates a schematic diagram of an example method according to an example 4 of the present disclosure.

The steps 600 to 603 are similar to steps 400 to 403 and will not be described again here.

In step 604, the candidate gNB-DU transmits a UE context modification response (UE CONTEXT MODIFICATION RESPONSE) message to the gNB-CU, and transmits cell group configuration information (CellGroupConfig) of the candidate cell to the gNB-CU, where the cell group configuration information contains information of the candidate SCell. The SCell information contains at least one of the following:
The identifier of one or more SCells, which may be a global cell ID (CGI), an SCell index (SCellIndex), or other cell identifiers.
The state of one or more SCells, which may include an activated state or a de-activated state.

The state of SCell is the state of the candidate SCell determined (that is, determining whether the state of the candidate SCell is the activated state or deactivated state) by the candidate gNB-DU finally based on the L1 measurement results of the candidate SCells or the identification information of the candidate SCells suggested to be activated obtained in step 603, in combination with the UE service state and/or the load status of the cell.

The gNB-CU includes the obtained cell group configuration information of the candidate cell in the RRC reconfiguration message to be transmitted to the UE, and transmits the RRC reconfiguration message to be transmitted to the UE to the source gNB-DU through step 605.

In step 605, the gNB-CU transmits a UE context modification confirm (UE CONTEXT MODIFICATION CONFIRM) message or a DL RRC message transfer (DL RRC MESSAGE TRANSFER) message or a UE context modification request (UE CONTEXT MODIFICATION REQUEST) message to the source gNB-DU. It contains the RRC reconfiguration message (RRCReconfiguration) transmitted by gNB-CU to the UE, which contains the candidate SCell information. The source gNB-DU transmits the received RRC reconfiguration message transmitted to the UE to the UE through step 606a.

In step 606a, the source gNB-DU transmits the RRC reconfiguration message (RRCReconfiguration) to the UE. The source gNB-DU transmits the RRC reconfiguration message transmitted to the UE by the gNB-CU in step 605 to the UE, which contains the candidate SCell information.

In step 606b, the UE transmits an RRC reconfiguration complete message (RRCReconfigurationComplete) to the source gNB-DU. It indicates that the UE has completed configuration update.

In step 607, the source gNB-DU transmits a UL RRC message transfer (UL RRC MESSAGE TRANSFER) message to the gNB-CU, transmits the RRC reconfiguration complete message received in step 606a to the gNB-CU, and indicates to the gNB-CU that the UE has completed the configuration update.

If step 601 does not contain the measurement value of the candidate cell, then step 608a is performed. If the source gNB-DU needs to indicate the UE to synchronize with the target cell or candidate, step 608b is performed. The steps 608a and 608b are similar to steps 406a and 406b, and will not be described again here.

In step 608, the source gNB-DU transmits a cell switch message or information to the UE, indicating the UE to perform cell switch and hand over to a target cell. The target cell is determined based on the L1 measurement result obtained in step 601 or 608a. The message contains at least one of the following information:

The target cell identifier, which may be a candidate cell index CandidateCellIndex or a global cell ID (CGI). The candidate cell index CandidateCellIndex indicates the index of the candidate cell in the list of all candidate cells. The value range is (0 to maxCandidateCells−1), where maxCandidateCells refers to the maximum number of candidate cells configured for the UE.

The UE obtains the target SCell information according to the identifier of the target cell and the RRC reconfiguration message received in step 606b, thereby determining the state of the target SCell.

If the source gNB-DU determines the target cell based on the L1 measurement result in step 601, the order of steps 607 and 608 is not specified or limited. That is, after the source gNB-DU receives the RRC reconfiguration complete message transmitted by the UE in step 606b, it determines that the UE has obtained information of the candidate SCell, and may trigger the UE to perform cell switch, that is, to perform the step 608.

In step 609, the UE accesses the target cell and indicates successful completion of cell switch.

In this step, the UE transmits a cell switch complete message or information, or transmits an LTM handover complete message or information to indicate that the UE has completed cell switch (or indicates that the UE has completed LTM handover), and accesses the target cell. The method for transmitting the cell switch complete message is shown in step 407, which will not be described again here.

When the UE accesses the target cell, the UE determines the operations that need to be performed based on the state of the target SCell. For the activated SCell, the UE performs related operations, such as monitoring the PDCCH for the SCell and/or monitoring the PDCCH on the SCell, and obtaining the scheduling/grant information of the SCell. The target gNB-DU performs related operations according to the SCell state, such as providing scheduling and/or grant information of the activated SCell to the UE through the PDCCH, for service transmission. The UE obtains the TA value of the target SCell through the target SCell identifier obtained in step 608 and information on the cell group to which the target SCell belongs, or performs a synchronization process according to the indication in step 608b to obtain the TA value of the target SCell. In this way, the UE may obtain the TA value of the target SCell in time before performing cell switch, enabling the target side to schedule for the target SCell of the UE timely, thereby improving handover performance.

The steps 610 and 611 are similar to steps 408 and 409, which will not be described again here.

Example 5 shows another method for indicating the state of a target SCell by a source cell during LTM handover.

In the example 5, before the source gNB-DU triggers an LTM handover, the source gNB-DU determines the target SCell and the state thereof based on the L1 measurement result of the SCell, and transmits a cell switch message or information to the UE, while transmitting the target PCell identifier or PSCell identifier and the target SCell information corresponding to the target PCell or PSCell to the UE. During the cell switch, the UE obtains information of the target SCell and determines the state of the target SCell in time, thereby ensuring handover performance. The UE may also avoid performing unnecessary operations according to the SCell state, thereby achieving energy saving for the UE.

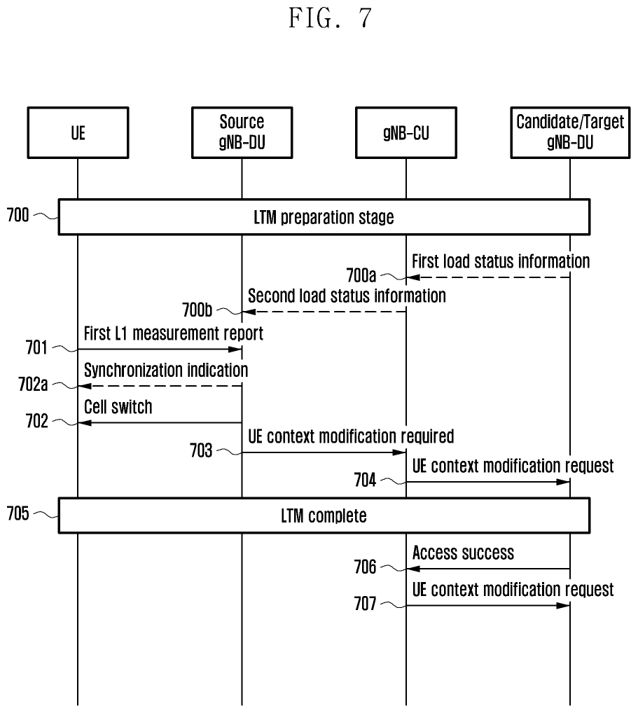

The specific process is shown in FIG. 7. FIG. 7 illustrates a schematic diagram of an example method according to an example 5 of the present disclosure.

The step 700 is similar to step 400 and will not be described again here.

The candidate gNB-DU monitors the cell load status. If the candidate SCell load status changes, steps 700a and 700b are performed. The candidate gNB-DU needs to transmit the load status information of the candidate SCell to the gNB-CU, and transmits it to the source gNB-DU through the gNB-CU.

In step 700a, the candidate gNB-DU transmits first load status information to the gNB-CU to provide load status information related to the candidate SCell. The load status information contains at least one of the following:
Candidate cell identifier, which may be a cell global ID (CGI), or a physical cell ID (PCI).
The identifier of one or more candidate SCells, which may be a global cell ID (CGI), an SCell index (SCellIndex), or other cell identifiers.
Load status information of one or more candidate SCell, which indicates the load status of the cell. For example, the load status may indicate a load level, the percentage of the load to the capacity, presence of overloading, and other information.

The first load status information may be transmitted through a resource status update (RESOURCE STATUS UPDATE) message, a gNB-DU status indication (GNB-DU STATUS INDICATION) message, or other messages.

In step 700b, the gNB-CU transmits second load status information to the source gNB-DU, which is used to transmit the load status information related to the candidate SCell transmitted by one or more candidate gNB-DUs to the source gNB-DU. The second load status information includes load status information of candidate SCells corresponding to the one or more candidate cells. The candidate SCell load status information of the candidate SCell corresponding to a candidate cell includes at least one of the following:
Identifier of one or more candidate cells, which may be a cell global ID (CGI), or a physical cell ID (PCI).
The identifier of one or more candidate SCells, which may be a global cell ID (CGI), an SCell index (SCellIndex), or other cell identifiers.
Load status information of one or more candidate SCells, which indicates the load status of the cell. For example, the load status may indicate a load level, the percentage of the load to the capacity, presence of overloading, and other information.

In step 701, the UE transmits a first L1 measurement report to a source gNB-DU, providing a first L1 measurement result. The first L1 measurement result includes the same content as described in step 401, which will not be described again here.

The source gNB-DU determines a target PCell or target PSCell based on the measurement result, and determines a corresponding target SCell based on the target PCell or target PSCell. It also selects one or more SCells from the target SCells as the activated target SCells according to the L1 measurement result of the SCell and the load status of the target SCell, and transmits the target SCell information to the UE in step 702 and to the gNB-CU in step 703, and to the target gNB-DU through the gNB-CU. The order of steps 702 and 703 is not specified or limited. The load status of the target SCell is determined by the source gNB-DU based on the load status information of the candidate SCell obtained in step 700b.

In step 702a, the source gNB-DU transmits synchronization indication information or message to the UE. It is similar to that described in 406b, and will not be described again here.

In step 702, the source gNB-DU transmits a cell switch message or information to the UE, indicating the UE to perform cell switch and hand over to a target cell. The message contains at least one of the following information:
The target cell identifier, which may be a candidate cell index CandidateCellIndex or a global cell ID (CGI). The candidate cell index CandidateCellIndex indicates the index of the candidate cell in the list of all candidate cells. The value range is (0 to maxCandidateCells-1), where maxCandidateCells refers to the maximum number of candidate cells configured for the UE.
Target SCell information, which includes at least one of the following:
   The identifier of one or more SCells, which may be a global cell ID (CGI), an SCell index (SCellIndex), or other cell identifiers.
   The state of one or more SCells, which may include an activated state or a de-activated state.

In step 703, the source gNB-DU transmits a UE context modification required (UE CONTEXT MODIFICATION REQUIRED) message to the gNB-CU. After transmitting the cell switch message or information to the UE, the source gNB-DU transmits the information of the target SCell to the gNB-CU and forwards it to the target gNB-DU through the gNB-CU. The target gNB-DU performs related operations according to the SCell state, such as providing scheduling and/or grant information of the activated SCell to the UE through the PDCCH, for service transmission. The message contains at least one of the following information:
Identifier of the target cell, identifier of the target cell selected by the source gNB-DU, identifier of the target PCell or target PSCell, where the identifier may be a global cell ID (CGI) or other cell identifiers.
The identification information of an activated target SCell, which includes the cell identifier of one or more target SCells. The cell identifier may be a global cell ID (CGI), an SCell index (SCellIndex), or other cell identifiers.
The SCell information, which contains at least one of the following:
   The identifier of one or more SCells, which may be a global cell ID (CGI), an SCell index (SCellIndex), or other cell identifiers.
   The state of one or more SCells, which may include an activated state or a de-activated state.

The gNB-CU transmits the received target cell identifier and/or the identification information of the activated target SCell and/or SCell information to the target gNB-DU in two modes:
Mode 1: After the gNB-CU receives the above information from the source gNB-CU, it transmits it to the target gNB-DU.
Mode 2: After the gNB-CU determines that the UE has accessed the target cell, the above information received from the source gNB-CU is transmitted to the target gNB-DU.

If Mode 1 is adopted, steps 704-706 are subsequently performed, while if Mode 2 is adopted, step 704 is not required and steps 705-707 are performed. Sequence relationship between steps 704 and 705 is not limited. When the UE receives the cell switch message or information in step 702, the UE starts to perform step 705.

In step 704, the gNB-CU transmits a UE context modification request (UE CONTEXT MODIFICATION REQUEST) to the target gNB-DU, and transmits the information received in step 703 to the target gNB-DU. The message contains at least one of the following information:
Identifier of the target cell;
Identification information of the activated target SCell;
Information of the SCell;
L1/L2 handover indication;
Candidate cell group configuration information;
Measurement configuration information.

Refer to step 703 for a detailed description of the target cell identifier, identification information of the activated target SCell, and information of the SCell, and refer to step 303 for a specific description of the L1/L2 handover indication, candidate cell group configuration information, and measurement configuration information, which will not be described again here.

In step 705, the UE accesses the target cell and indicates successful completion of cell switch.

In this step, the UE transmits a cell switch complete message or information, or transmits an LTM handover complete message or information to indicate that the UE has completed cell switch (or indicates that the UE has completed LTM handover), and accesses the target cell. The method for transmitting the cell switch complete message is shown in step 407, which will not be described again here.

When the UE accesses the target cell, the UE determines the operations that need to be performed based on the state of the target SCell. For the activated SCell, the UE performs related operations, such as monitoring the PDCCH for the SCell and/or monitoring the PDCCH on the SCell, and obtaining the scheduling/grant information of the SCell. If Mode 1 is adopted, the target gNB-DU obtains the target SCell state in step 704. When in step 705, the target gNB-DU determines that the UE has accessed the target cell, it can perform relevant operations according to the SCell state, such as providing scheduling and/or grant information of the activated SCell to the UE through the PDCCH for service transmission. The UE obtains the TA value of the target SCell through the target SCell identifier obtained in step 702 and information on the cell group to which the target SCell belongs, or performs a synchronization process according to the indication in step 702a to obtain the TA value of the target SCell. In this way, the UE may obtain the TA value of the target SCell in time before performing cell switch, enabling the target side to schedule for the target SCell of the UE timely, thereby improving handover performance.

In step 706, the target gNB-DU transmits an access success (ACCESS SUCCESS) message to the gNB-CU, indicating that the UE successfully accesses the target cell. The access success message at least includes the target cell identifier.

In step 707, the gNB-CU transmits a UE context modification request (UE CONTEXT MODIFICATION REQUEST) to the target gNB-DU. If Mode 2 is adopted, when the gNB-CU determines that the UE has accessed the target cell through step 706, it transmits the information received in step 703 to the target gNB-DU. The target gNB-DU performs related operations according to the SCell state, such as providing scheduling and/or grant information of the activated SCell to the UE through the PDCCH, for service transmission. The message contains at least one of the following information:
Identifier of the target cell;
Identification information of the activated target SCell;
Information of the SCell;
L1/L2 handover indication;
Candidate cell group configuration information;
Measurement configuration information.

Refer to step 703 for a detailed description of the target cell identifier, identification information of the activated target SCell, and information of the SCell, and refer to step 303 for a specific description of the L1/L2 handover indication, candidate cell group configuration information, and measurement configuration information, which will not be described again here.

Example 6 shows a method for indicating the state of a target SCell by a target cell during LTM handover.

In the example 6, the UE receives a cell switch message or information from the source gNB-DU, indicating the UE to perform cell switch and hand over to the target cell. When the UE accesses the target cell, it transmits a cell switch complete message or information that indicates that the UE has completed cell switch (or indicates that the UE has completed LTM handover) and has accessed to the target cell. The method for transmitting by the UE the cell switch complete message or information to the target gNB-DU is shown in step 407, which will not be described again here. At the same time, the UE may transmit a second L1 measurement report (providing a second L1 measurement result) to the target gNB-DU. The second L1 measurement result is obtained by measurement performed by the UE before switching to the target cell.

There are two modes for the UE to transmit the second L1 measurement report to the target gNB-DU:
Mode 1: the second L1 measurement report may be included in the cell switch complete message or information and transmitted to the target gNB-DU.
Mode 2: after transmitting the cell switch complete message or information, the second L1 measurement report is transmitted to the target gNB-DU separately.

The second L1 measurement report includes the L1 measurement result of the target SCell, which is used by the target gNB-DU to determine the state of the target SCell and is provided to the UE.

After the UE accesses the target cell, it reports the L1 measurement result to the target gNB-DU timely, so that the target gNB-DU may determine the state of the SCell timely and provide it to the UE. When the UE accesses the target cell, its service quality is guaranteed. At the same time, the UE can avoid performing unnecessary operations according to the SCell state, thereby achieving energy saving for the UE.

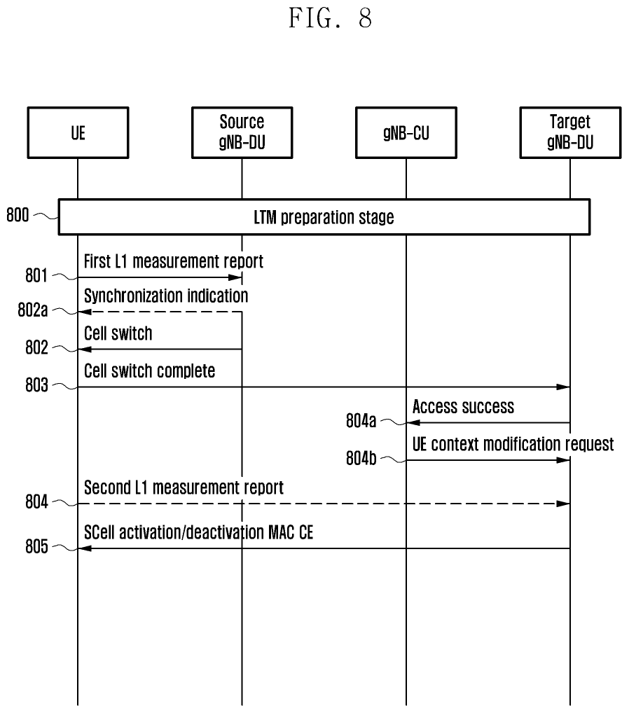

The specific process is shown in FIG. 8. FIG. 8 illustrates a schematic diagram of an example method according to an example 6 of the present disclosure.

The steps 800 to 801 are similar to steps 500 to 501 and will not be described again here.

In step 802a, the source gNB-DU transmits synchronization indication information or message to the UE. It is similar to that described in 406b, and will not be described again here.

In step 802, the source gNB-DU transmits a cell switch message or information to the UE, indicating the UE to perform cell switch and hand over to a target cell. The message contains at least one of the following information:
The target cell identifier, which may be a candidate cell index CandidateCellIndex or a global cell ID (CGI). The candidate cell index CandidateCellIndex indicates the index of the candidate cell in the list of all candidate cells. The value range is (0 to maxCandidateCells−1), where maxCandidateCells refers to the maximum number of candidate cells configured for the UE.

If Mode 1 is used to transmit the second L1 measurement report to the target gNB-DU, then steps 803, 804a, 804 b and 805 are performed subsequently, while if Mode 2 is used to transmit the second L1 measurement report to the target gNB-DU, then steps 803, 804a, 804 b, 804 and 805 are performed subsequently.

In step 803, the UE transmits a cell switch complete message or information to the target gNB-DU.

In this step, the UE transmits a cell switch complete message or information, or transmits an LTM handover complete message or information to indicate that the UE has completed cell switch (or indicates that the UE has completed LTM handover), and accesses the target cell. The method for transmitting the cell switch complete message is shown in step 407, which will not be described again here.

If the Mode 1 is used to transmit the second L1 measurement report to the target gNB-DU, the second L1 measurement report may be included in a cell switch complete message or information and transmitted simultaneously with the cell switch complete indication. The second L1 measurement report may be transmitted through a physical uplink control channel (PUCCH), for example, in the form of a MAC CE or other forms; or may be transmitted through a physical uplink shared channel (PUSCH), for example, in the form of uplink control information (UCI).

The second L1 measurement report, which provides a second L1 measurement result, including at least one of the following:
The identifier of one or more target SCells, which may be a global cell ID (CGI), an SCell index (SCellIndex), or other cell identifiers.
Measurement value of one or more target SCells, for example, a RSRP value. The RSRP may be SSB RSRP, or CSI RSRP, or a RSRP value of other signals.

In step 804a, the target gNB-DU transmits an access success (ACCESS SUCCESS) message to the gNB-CU, indicating that the UE successfully accesses the target cell. The access success message at least includes the target cell identifier.

In step 804b, the gNB-CU transmits a UE context modification request (UE CONTEXT MODIFICATION REQUEST) to the target gNB-DU. The message contains at least one of the following information:
L1/L2 handover indication;
Candidate cell group configuration information;
Measurement configuration information.

Refer to step 303 for a specific description of the L1/L2 handover indication, candidate cell group configuration information, and measurement configuration information, which will not be described again here.

In step 804, the UE transmits a second L1 measurement report to a target gNB-DU. The second L1 measurement result includes the same content as described in step 803, which will not be described again here.

The second L1 measurement report is transmitted through a PUSCH channel, such as in the form of a MAC CE or other forms; or transmitted through a PUCCH channel, such as in the form of uplink control information (UCI).

The target gNB-DU finally determines the state of the target SCell (that is, whether the state of the target SCell is an activated state or a deactivated state) based on the L1 measurement result of the target SCell obtained through step 803 or step 804 in combination with the UE service state and/or the load status of the cell, and transmits the state of the target SCell to the UE.

In step 805, the target gNB-DU transmits an SCell activation/deactivation MAC CE to the UE to indicate the state of the target SCell.

Example 7 shows another method for indicating the state of a target SCell by a target cell during LTM handover.

In the example 7, the target gNB-DU promptly determines a target SCell and the state thereof based on the L1 measurement result of the SCell, and transmits the state of the target SCell to the UE after the UE accesses the target cell. This enables the UE to instantly obtain the state of the target SCell, ensuring handover performance and guaranteeing the service quality in the target cell, and enables the UE to avoid performing unnecessary operations based on the SCell state, thereby achieving energy saving for the UE.

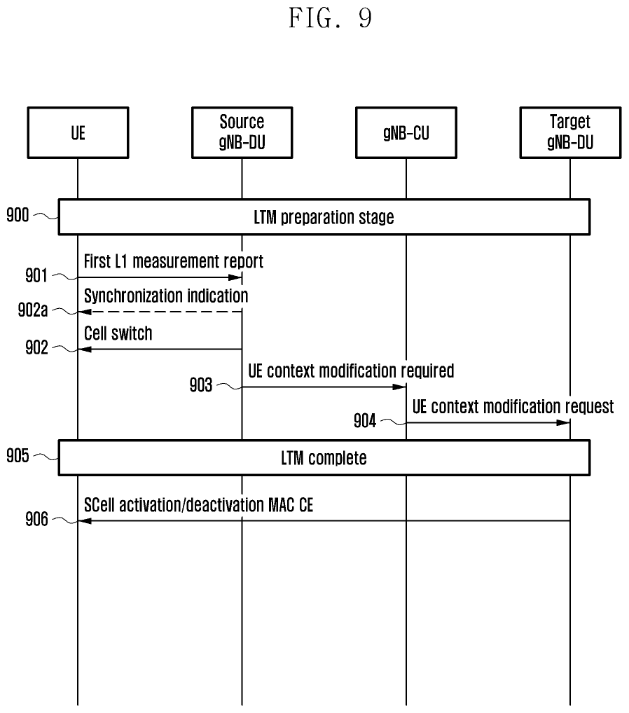

The specific process is shown in FIG. 9. FIG. 9 illustrates a schematic diagram of an example method according to an example 7 of the present disclosure.

The steps 900 to 902a are similar to steps 800 to 802a and will not be described again here.

In step 903, the source gNB-DU transmits a UE context modification required (UE CONTEXT MODIFICATION REQUIRED) message to the gNB-CU. The source gNB-DU forwards the L1 measurement result of the target SCell received in step 901 to the gNB-CU, and/or determines the activated target SCell based on the L1 measurement result, and transmits the identification information of the target SCell suggested to be activated to the gNB-CU. The message contains at least one of the following information:

Identifier of the target cell, identifier of the target cell selected by the source gNB-DU, identifier of the target PCell or target PSCell, where the identifier may be a global cell ID (CGI) or other cell identifiers.
L1 measurement result, including at least one of the following:
   Measurement result of the target SCell, including at least one of the following:
      The identifier of one or more target SCells, which may be a global cell ID (CGI), an SCell index (SCellIndex), or other cell identifiers.
      Measurement value of one or more target SCells, for example, a RSRP value. The RSRP may be SSB RSRP, or CSI RSRP, or a RSRP value of other signals.
The identification information of the target SCell suggested to be activated, which includes the cell identifier of one or more target SCells. The cell identifier may be a global cell ID (CGI), an SCell index (SCellIndex), or other cell identifiers.

In step 904, the gNB-CU transmits a UE context modification request (UE CONTEXT MODIFICATION REQUEST) to the target gNB-DU, and transmits the information received in step 903 to the target gNB-DU. The message contains at least one of the following information:
Identifier of the target cell. Refer to step 903 for the specific description of the identifier of the target cell, which will not be described again here.
Measurement result of the target SCell. The gNB-CU transmits the L1 measurement result of the target SCell received in step 903 to the target gNB-DU. The measurement result of the target SCell is shown in step 903, which will not be described again here.
The identification information of the target SCell suggested to be activated. The gNB-CU transmits the identification information of the target SCell suggested to be activated received in step 903 to the target gNB-DU. The content of the identification information of the target SCell suggested to be activated is shown in step 903, which will not be described again here.
Service state of the UE. If the SRB and/or DRB established by the UE on the SCell changes, the service state of the UE needs to be included and the updated SRB and/or DRB information needs to be provided to the target gNB-DU. The changes include update of the SRB/DRB information or deletion of the SRB/DRB.
L1/L2 handover indication;
Candidate cell group configuration information;
Measurement configuration information.

Refer to step 303 for a specific description of the L1/L2 handover indication, candidate cell group configuration information, and measurement configuration information, which will not be described again here.

The target gNB-DU finally determines the state of the target SCell based on the obtained measurement result of the target SCell or the identification information of the target SCell suggested to be activated in combination with the UE service state and/or the load status of the cell. After the UE accesses the target cell, the state of the target SCell is transmitted to the UE through step 906.

In step 905, the UE accesses the target cell and indicates successful completion of cell switch.

In this step, the UE transmits a cell switch complete message or information, or transmits an LTM handover complete message or information to indicate that the UE has completed cell switch (or indicates that the UE has completed LTM handover), and accesses the target cell. The method for transmitting the cell switch complete message is shown in step 407, which will not be described again here.

After the UE accesses the target cell, it waits to receive the state information of the target SCell provided by the target gNB-DU and determines the operations that need to be performed.

In step 906, the target gNB-DU transmits an SCell activation/deactivation MAC CE to the UE to indicate the state of the target SCell.

Based on the received state of the SCell, the UE performs related operations for the activated SCell, such as monitoring the PDCCH for the SCell and/or monitoring the PDCCH on the SCell, and obtaining the scheduling/grant information of the SCell. The target gNB-DU performs related operations according to the SCell state, such as providing scheduling and/or grant information of the activated SCell to the UE through the PDCCH, for service transmission.

Example 8 shows another method for indicating the state of a target SCell by a target cell during LTM handover.

In the example 8, the target gNB-DU determines the target SCell and the state thereof based on the L1 measurement result of the SCell, and transmits the state of the target SCell to the UE after the UE accesses the target cell. This enables the UE to instantly obtain the state of the target SCell, ensuring handover performance, and enables the UE to avoid performing unnecessary operations based on the SCell state, thereby achieving energy saving for the UE.

Principles of the methods in the example 8 and example 7 are similar, except that in the example 8, when the gNB-CU obtains the measurement result of the target SCell and/or the identification information of the target SCell suggested to be activated from the source gNB-DU, the gNB-CU does not directly transmit it to the target gNB-DU, but after the gNB-CU determines that the UE has accessed the target cell, it transmits the measurement result of the target SCell and/or the identification information of the target SCell suggested to be activated to the target gNB-DU.

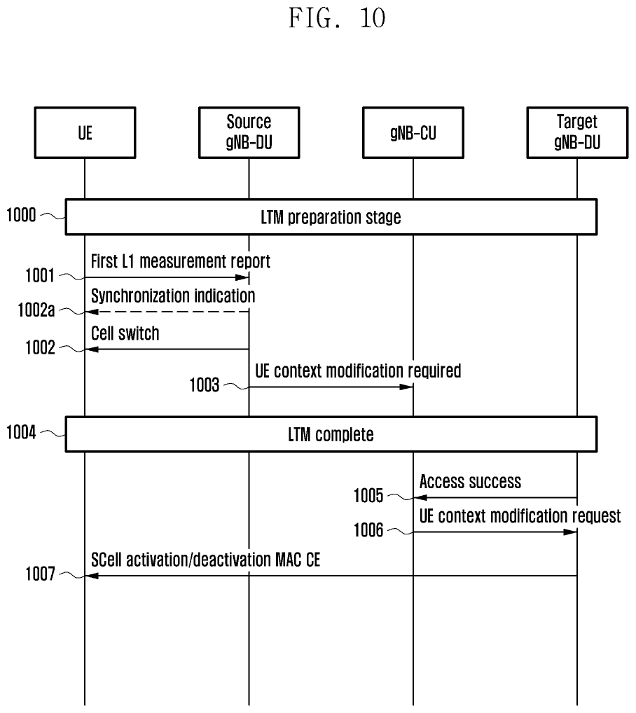

The specific process is shown in FIG. 10. FIG. 10 illustrates a schematic diagram of an example method according to an example 8 of the present disclosure.

The steps 1000 to 1003 are similar to steps 900 to 903 and will not be described again here.

The step 1004 is similar to step 905 and will not be described again here.

In step 1005, the target gNB-DU transmits an access success (ACCESS SUCCESS) message to the gNB-CU, indicating that the UE successfully accesses the target cell. The access success message at least includes the target cell identifier.

In step 1006, the gNB-CU transmits a UE context modification request (UE CONTEXT MODIFICATION REQUEST) to the target gNB-DU, and transmits the information received in step 1003 to the target gNB-DU. Refer to step 904 for information included in the message, which will not be described again here.

The target gNB-DU finally determines the state of the target SCell based on the obtained measurement result of the target SCell or the identification information of the target SCell suggested to be activated in combination with the UE service state and/or the load status of the cell. After the UE accesses the target cell, the state of the target SCell is transmitted to the UE through step 1007.

In step 1007, the target gNB-DU transmits an SCell activation/deactivation MAC CE to the UE to indicate the state of the target SCell.

Based on the received state of the SCell, the UE performs related operations for the activated SCell, such as monitoring the PDCCH for the SCell and/or monitoring the PDCCH on the SCell, and obtaining the scheduling/grant information of the SCell. The target gNB-DU performs related operations according to the SCell state, such as providing scheduling and/or grant information of the activated SCell to the UE through the PDCCH, for service transmission.

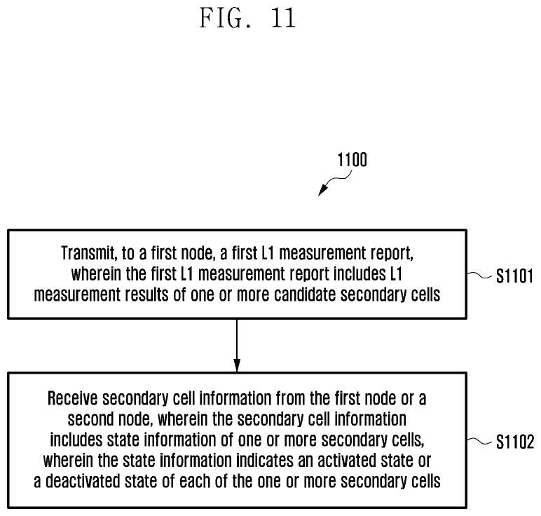

Next, FIG. 11 illustrates a flowchart of a method 1100 performed by a user equipment (UE) in a wireless communication system according to embodiments of the present disclosure. As shown in FIG. 11, the method 1100 may include step S1101 and step S1102. In step S1101, the method 1100 may include transmitting a first L1 measurement report to a first node. In some implementations, the first L1 measurement report may include L1 measurement results of one or more candidate secondary cells. In some implementations, a candidate secondary cell may be a candidate target secondary cell for handover, which may also be referred to as a target candidate secondary cell. In step S1102, the method 1100 may include receiving secondary cell information from the first node or a second node. In some implementations, the secondary cell information may include state information of one or more secondary cells, and the state information may indicate an activated state or a deactivated state of one or more secondary cells. In some implementations, the first node may be a source gNB-DU; the second node may be a target gNB-DU and/or candidate gNB-DU; and the third node may be a gNB-CU, and so on. It should be understood that in other implementations, each of the first node, the second node and the third node described in the present disclosure may be any one of a source gNB-DU, a target gNB-DU and/or a candidate gNB-DU, and a gNB-CU. The messages or signaling exchanged between the first node, the second node, the third node and the UE may be any combination of various messages or signaling as shown above in conjunction with various figures, embodiments or examples.

According to embodiments of the present disclosure, the method further includes: transmitting to the first node a third L1 measurement report, wherein the third L1 measurement report includes L1 measurement results of one or more source candidate secondary cells; and receiving from the first node a source secondary cell activation/ deactivation media access control (MAC) control element (CE) for indicating an activated state or deactivated state of each of the one or more source secondary cells.

According to embodiments of the present disclosure, receiving secondary cell information from the first node further includes at least one of the following: receiving a message indicating cell switch from the first node, wherein the message indicating cell switch includes the secondary cell information; receiving a radio resource control (RRC) reconfiguration message from the first node, wherein the RRC reconfiguration message includes the secondary cell information.

According to embodiments of the present disclosure, the message indicating cell switch includes a target cell identifier of a target cell for cell switch and/or secondary cell information of a target secondary cell corresponding to the target cell.

According to embodiments of the present disclosure, the receiving from the second node secondary cell information further includes: transmitting to the second node a second L1 measurement report, wherein the second L1 measurement report includes L1 measurement results of one or more target secondary cells; and receiving from the second node a secondary cell activation/deactivation media access control (MAC) control element (CE) for indicating an activated state or deactivated state of each of the one or more source secondary cells.

According to embodiments of the present disclosure, the method further includes: transmitting a message indicating completion of cell switch to the second node, wherein the second L1 measurement report is included in the message.

According to embodiments of the present disclosure, the first L1 measurement report and/or the second L1 measurement report and/or the third L1 measurement report are transmitted via a media access control (MAC) control element (CE) over a physical uplink shared channel (PUSCH), or via an uplink control information (UCI) over a physical uplink control channel (PUCCH).

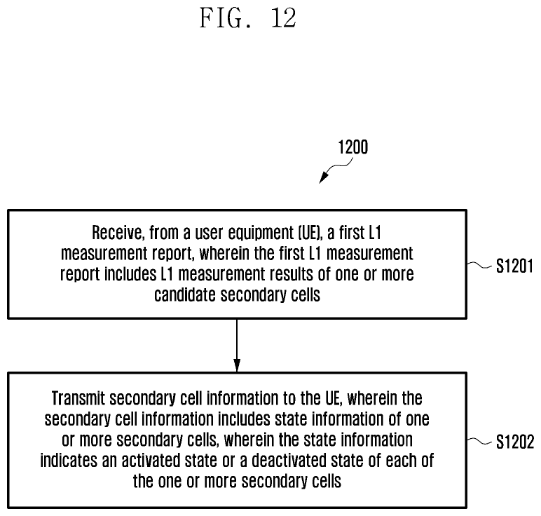

FIG. 12 illustrates a flowchart of a method 1200 performed by a first node in a wireless communication system according to embodiments of the present disclosure. As shown in FIG. 12, the method 1200 may include step S1201 and step S1202. In step S1201, the method 1200 may include receiving a first L1 measurement report from a user equipment (UE). In some implementations, the first L1 measurement report may include L1 measurement results of one or more candidate secondary cells. In some implementations, a candidate secondary cell may be a candidate target secondary cell for handover, which may also be referred to as a target candidate secondary cell. In step S1202, the method 1200 may include transmitting secondary cell information to the UE. In some implementations, the secondary cell information may include state information of one or more secondary cells, and the state information may indicate an activated state or a deactivated state of one or more secondary cells. In some implementations, the first node may be a source gNB-DU; the second node may be a target gNB-DU and/or candidate gNB-DU; and the third node may be a gNB-CU, and so on. It should be understood that in other implementations, each of the first node, the second node and the third node described in the present disclosure may be any one of a source gNB-DU, a target gNB-DU and/or a candidate gNB-DU, and a gNB-CU. The messages or signaling exchanged between the first node, the second node, the third node and the UE may be any combination of various messages or signaling as shown above in conjunction with various figures, embodiments or examples.

According to embodiments of the present disclosure, the method further includes: transmitting a message indicating cell switch to the UE, wherein the message indicating cell switch includes the secondary cell information, wherein the message indicating cell switch includes a target cell identifier of a target cell for cell switch and/or secondary cell information of a target secondary cell corresponding to the target cell.

According to embodiments of the present disclosure, the method further includes: receiving, from a third node, load status information from a second node, wherein the load status information includes a load status of each of the one or more candidate secondary cells; and transmitting target secondary cell information to the third node, wherein the target secondary cell information is transmitted to the second node through the third node.

According to embodiments of the present disclosure, the method further includes: determining the secondary cell information according to the first L1 measurement report and/or the load status information.

According to embodiments of the present disclosure, the method further includes: receiving the secondary cell information from a third node, wherein the secondary cell information is determined and transmitted to the third node by a second node.

According to embodiments of the present disclosure, the method further includes: transmitting a radio resource control (RRC) reconfiguration message to the UE, wherein the RRC reconfiguration message includes the secondary cell information.

According to embodiments of the present disclosure, the method further includes: transmitting, to a third node, the L1 measurement results of the one or more candidate secondary cells and/or identification information of a candidate secondary cell suggested to be activated, wherein the L1 measurement result of the one or more candidate secondary cells and/or the identification information of the candidate secondary cell suggested to be activated is transmitted to a second node through the third node for determining candidate secondary cell information, wherein the identification information of the candidate secondary cell suggested to be activated is determined based on the first L1 measurement report.

According to embodiments of the present disclosure, the method further includes:

transmitting, to a third node, an L1 measurement result of a target secondary cell corresponding to a target cell for cell switch and/or identification information of a target secondary cell suggested to be activated, wherein the L1 measurement result of the target secondary cell corresponding to the target cell for cell switch and/or the identification information of the target secondary cell suggested to be activated is transmitted to a second node through the third node for determining target secondary cell information, wherein the target cell and the identification information of the target secondary cell suggested to be activated is determined based on the first L1 measurement report.

According to embodiments of the present disclosure, the method further includes: receiving from the UE a third L1 measurement report, wherein the third L1 measurement report includes L1 measurement results of one or more source candidate secondary cells; and transmitting a source secondary cell activation/deactivation media access control (MAC) control element (CE) to the UE for indicating an activated state or deactivated state of each of the one or more source secondary cells.

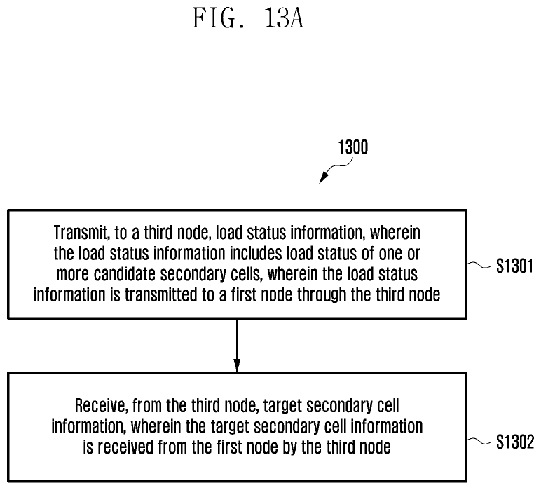

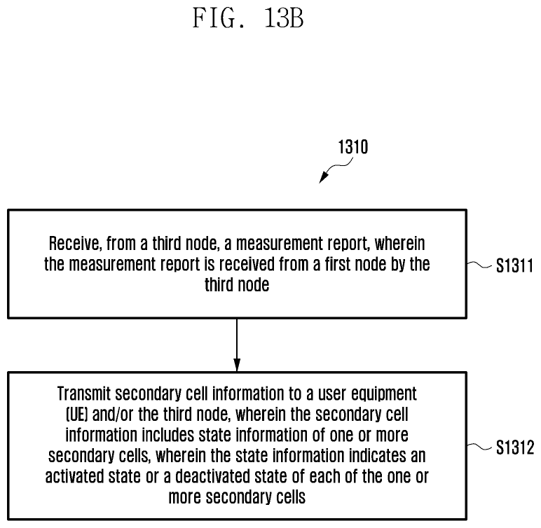

FIG. 13a illustrates a flowchart of a method 1300 performed by a second node in a wireless communication system according to embodiments of the present disclosure. As shown in FIG. 13a, the method 1300 may include step S1301 and step S1302. In step S1301, the method 1300 may include transmitting load status information to a third node. In some implementations, the load status information may include load status information of one or more candidate secondary cells. In some implementations, the load status information may be transmitted to a first node through the third node. In step S1302, the method 1300 may include receiving target secondary cell information from the third node. In some implementations, the target secondary cell information may be received by the third node from a first node. In some implementations, the secondary cell information may include state information of one or more secondary cells, and the state information may indicate an activated state or a deactivated state of one or more secondary cells. In some implementations, the first node may be a source gNB-DU; the second node may be a target gNB-DU and/or candidate gNB-DU; and the third node may be a gNB-CU, and so on. It should be understood that in other implementations, each of the first node, the second node and the third node described in the present disclosure may be any one of a source gNB-DU, a target gNB-DU and/or a candidate gNB-DU, and a gNB-CU. The messages or signaling exchanged between the first node, the second node, the third node and the UE may be any combination of various messages or signaling as shown above in conjunction with various figures, embodiments or examples.

According to embodiments of the present disclosure, the method further includes: monitoring a load status of a cell in the second node; if the load status of the cell changes, determining an updated load status of the cell; and including the updated load status in the load status information.

FIG. 13b illustrates a flowchart of a method 1310 performed by a second node in a wireless communication system according to embodiments of the present disclosure. As shown in FIG. 13b, the method 1310 may include step S1311 and step S1312. In step S1311, the method 1310 may include receiving a measurement report from a third node. In step S1312, the method 1310 may include transmitting secondary cell information to a user equipment (UE) and/or third node. In some implementations, the secondary cell information may include state information of one or more secondary cells, and the state information may indicate an activated state or a deactivated state of one or more secondary cells. In some implementations, the first node may be a source gNB-DU; the second node may be a target gNB-DU and/or candidate gNB-DU; and the third node may be a gNB-CU, and so on. It should be understood that in other implementations, each of the first node, the second node and the third node described in the present disclosure may be any one of a source gNB-DU, a target gNB-DU and/or a candidate gNB-DU, and a gNB-CU. The messages or signaling exchanged between the first node, the second node, the third node and the UE may be any combination of various messages or signaling as shown above in conjunction with various figures, embodiments or examples.

According to embodiments of the present disclosure, the transmitting secondary cell information to the third node further includes: receiving L1 measurement results of one or more candidate secondary cells from the third node and/or identification information of a candidate secondary cell suggested to be activated; and transmitting secondary cell information of the one or more candidate secondary cells to the third node.

According to embodiments of the present disclosure, the transmitting secondary cell information to the third node further includes: receiving, from the third node, an L1 measurement result of a target secondary cell corresponding to a target cell for cell switch and/or identification information of a target secondary cell suggested to be activated; and transmitting secondary cell information of one or more target secondary cells to the third node.

According to embodiments of the present disclosure, the receiving from the third node an L1 measurement result of a target secondary cell corresponding to a target cell for cell switch and/or identification information of a target secondary cell suggested to be activated further includes: after transmitting indication information indicating that the UE successfully accesses a target cell to the third node, receiving from the third node the L1 measurement result of the target secondary cell corresponding to the target cell for cell switch and/or the identification information of the target secondary cell suggested to be activated.

According to embodiments of the present disclosure, the transmitting secondary cell information to the UE further includes: receiving a second L1 measurement report from the UE, wherein the second L1 measurement report includes L1 measurement results of one or more target secondary cells; and transmitting to the UE a secondary cell activation/deactivation media access control (MAC) control element (CE) for indicating an activated state or deactivated state of each of the one or more source secondary cells.

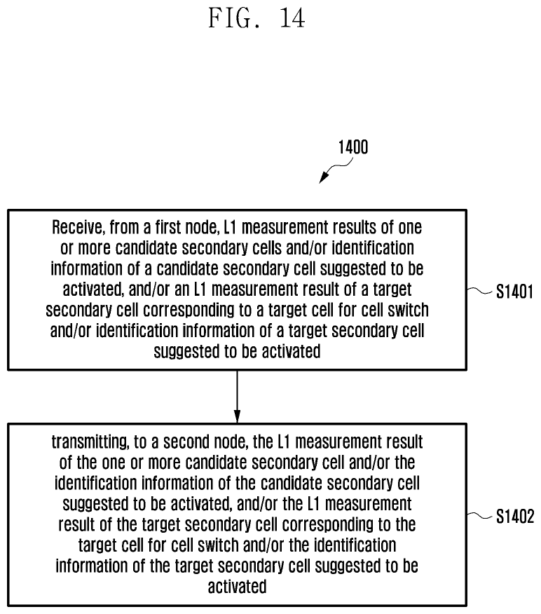

FIG. 14 illustrates a flowchart of a method 1400 performed by a third node in a wireless communication system according to embodiments of the present disclosure. As shown in FIG. 14, the method 1400 may include step S1401 and step S1402. In step S1401, the method 1400 may include receiving from a first node L1 measurement results of one or more candidate secondary cells and/or identification information of a candidate secondary cell suggested to be activated, and/or an L1 measurement result of a target secondary cell corresponding to a target cell for cell switch and/or identification information of a target secondary cell suggested to be activated. In some implementations, a candidate secondary cell may be a candidate target secondary cell for handover, which may also be referred to as a target candidate secondary cell. In step S1402, the method 1400 may include transmitting to a second node the L1 measurement result of the one or more candidate secondary cell and/or the identification information of the candidate secondary cell suggested to be activated, and/or the L1 measurement result of the target secondary cell corresponding to the target cell for cell switch and/or the identification information of the target secondary cell suggested to be activated. In some implementations, the first node may be a source gNB-DU; the second node may be a target gNB-DU and/or candidate gNB-DU; and the third node may be a gNB-CU, and so on. It should be understood that in other implementations, each of the first node, the second node and the third node described in the present disclosure may be any one of a source gNB-DU, a target gNB-DU and/or a candidate gNB-DU, and a gNB-CU. The messages or signaling exchanged between the first node, the second node, the third node and the UE may be any combination of various messages or signaling as shown above in conjunction with various figures, embodiments or examples.

According to embodiments of the present disclosure, the method further includes: transmitting, to a first node, load status information from a second node, wherein the load status information includes a load status of each of the one or more candidate secondary cells; and receiving from the first node target secondary cell information, wherein the target secondary cell information is transmitted to the second node through the third node.

According to embodiments of the present disclosure, the method further includes: receiving, from the second node, secondary cell information; and transmitting the secondary cell information to the first node, wherein the secondary cell information includes state information of one or more secondary cells, wherein the state information indicates an activated state or a deactivated state of each of the one or more secondary cells.

According to embodiments of the present disclosure, the one or more secondary cells include one or more candidate secondary cells or one or more target secondary cells.

According to embodiments of the present disclosure, the transmitting to a second node the L1 measurement result of the target secondary cell corresponding to the target cell for cell switch and/or the identification information of the target secondary cell suggested to be activated further includes: after receiving from the second node information indicating that a user equipment (UE) successfully accesses the target cell, transmitting to the second node the L1 measurement result of the target secondary cell corresponding to the target cell for cell switch and/or the identification information of the target secondary cell suggested to be activated.

It should be understood that the methods 1100, 1200, 1300, 1310 and 1400 according to embodiments of the present disclosure may also include one or more of the methods or steps as described above with reference to any examples or drawings, which will not be described again here.

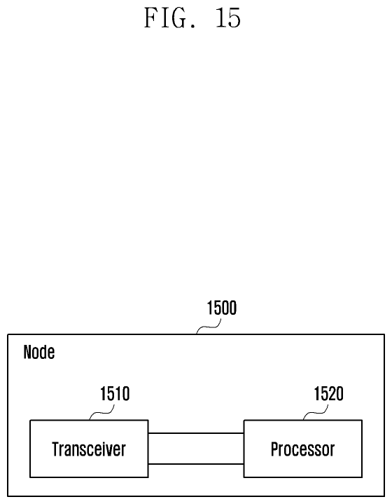

Next, FIG. 15 illustrates a schematic diagram of a node 1500 in a wireless communication system according to embodiments of the present disclosure.

As shown in FIG. 15, a node 1500 according to embodiments of the present disclosure (for example, it may be a first node, a second node, a third node or any other network node as described above) may include a transceiver 1510 and a processor 1520. The transceiver 1510 may be configured to transmit and receive signals. The processor 1520 may be coupled with the transceiver 1510, and may be configured to implement any method performed by a node in a wireless communication system in accordance with embodiments of the present disclosure (e.g., by controlling the transceiver 1510).

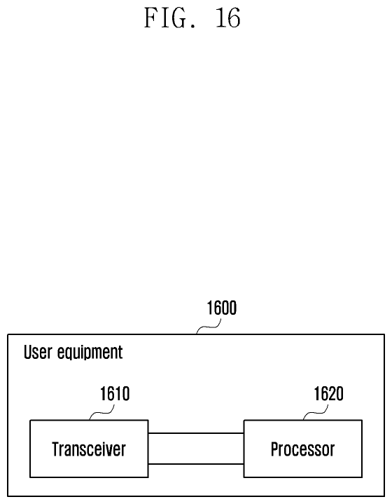

FIG. 16 illustrates a schematic diagram of a user equipment 1600 in a wireless communication system according to embodiments of the present disclosure.

As shown in FIG. 16, the user equipment 1600 according to embodiments of the present disclosure may include a transceiver 1610 and a processor 1620. The transceiver 1610 may be configured to transmit and receive signals. The processor 1620 may be coupled with the transceiver 1610, and may be configured to implement any method performed by a user equipment in accordance with embodiments of the present disclosure (e.g., by controlling the transceiver 1610). The processor may also be referred to as a controller herein.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which embodiments of the present disclosure are applied.

It will be understood that embodiments of the present disclosure may be implemented in the form of hardware, software, or a combination of hardware and software. The software may be stored as program indications or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with indications for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1. A method performed by a distributed unit (DU) of a source base station in a wireless communication system, the method comprising:
receiving, from a terminal, an layer 1 (L1) measurement report including information on L1 measurement results for candidate secondary cells (SCells); and
transmitting, to the terminal, a message for cell switch including SCell information,
wherein the SCell information includes information indicating an activated state or a deactivated state for each of at least one SCell among the candidate SCells.

2. The method of claim 1, further comprising:
receiving, from a target base station via a central unit (CU) of the source base station, load status information including information on a load status for each of the candidate SCells; and
determining the SCell information based on the L1 measurement report and the load status information.

3. The method according to claim 2, further comprising:
transmitting, to the target base station via the CU of the source base station, the information on the measurement results for the candidate SCells and identification information for at least one candidate SCell among the candidate SCells which is suggested to be activated;
receiving, from the target base station via the CU of the source base station, target SCell information indicating the activated state or the de-activated state for each of the at least one candidate SCell,
wherein the SCell information is determined based on the target SCell information, and
wherein the message further includes information on an identifier of a target cell for the cell switch.

4. A method performed by a terminal in a wireless communication system, the method comprising:
transmitting, to a distributed unit (DU) of a source base station, an layer 1 (L1) measurement report including information on L1 measurement results for candidate secondary cells (SCells); and
receiving, from the DU of the source base station, a message for cell switch including SCell information,
wherein the SCell information includes information indicating an activated state or a deactivated state for each of at least one SCell among the candidate SCells.

5. The method of claim 4,
wherein the message is a radio resource control (RRC) reconfiguration message, and
wherein the RRC reconfiguration message further includes information on an identifier of a target cell for the cell switch.

6. A method performed by a distributed unit (DU) of a target base station in a wireless communication system, the method comprising:
receiving, from a DU of a source base station via a central unit (CU) of the source base station, information on an layer 1 (L1) measurement report including information on L1 measurement results for candidate secondary cells (SCells) and identification information for at least one candidate SCell among the candidate SCells which is suggested to be activated;
determining target SCell information indicating an activated state or a deactivated state for each of the at least one candidate SCell; and
transmitting, to the DU of the source base station via the CU of the source base station, the target SCell information,
wherein SCell information associated with cell switch of a terminal is determined based on the target SCell information, and
wherein the SCell information includes information indicating the activated state or the deactivated state for each of at least one SCell among the candidate SCells.

7. The method of claim 6, further comprising:
transmitting, to the DU of the source base station via the CU of the source base station, load status information including information on a load status for each of the candidate SCells,
wherein the SCell information is determined further based on the load status information.

8. A distributed unit (DU) of a source base station in a wireless communication system, the DU of the source base station method comprising:
a transceiver; and
a controller configured to:
control the transceiver to receive, from a terminal, an layer 1 (L1) measurement report including information on L1 measurement results for candidate secondary cells (SCells), and
control the transceiver to transmit, to the terminal, a message for cell switch including SCell information,
wherein the SCell information includes information indicating an activated state or a deactivated state for each of at least one SCell among the candidate SCells.

9. The DU of the source base station of claim 8, wherein the controller is further configured to:
control the transceiver to receive, from a target base station via a central unit (CU) of the source base station, load status information including information on a load status for each of the candidate SCells, and
determine the SCell information based on the L1 measurement report and the load status information.

10. The DU of the source base station of claim 9,
wherein the controller is further configured to control the transceiver to transmit, to the target base station via the CU of the source base station, the information on the measurement results for the candidate SCells and identification information for at least one candidate SCell among the candidate SCells which is suggested to be activated, and control the transceiver to receive, from the target base station via the CU of the source base station, target SCell information indicating the activated state or the deactivated state for each of the at least one candidate SCell,
wherein the SCell information is determined based on the target SCell information, and
wherein the message further includes information on an identifier of a target cell for the cell switch.

11. A terminal in a wireless communication system, the terminal comprising:
a transceiver; and
a controller configured to:
control the transceiver to transmit, to a distributed unit (DU) of a source base station, an layer 1 (L1) measurement report including information on L1 measurement results for candidate secondary cells (SCells), and control the transceiver to receive, from the DU of the source base station, a message for cell switch including SCell information,
wherein the SCell information includes information indicating an activated state or a deactivated state for each of at least one SCell among the candidate SCells.

12. The terminal of claim 11,
wherein the message is a radio resource control (RRC) reconfiguration message, and
wherein the RRC reconfiguration message further includes information on an identifier of a target cell for the cell switch.

13. A distributed unit (DU) of a target base station in a wireless communication system, the DU of the target base station comprising:
a transceiver; and
a controller configured to:
control the transceiver to receive, from a DU of a source base station via a central unit (CU) of the source base station, information on an layer 1 (L1) measurement report including information on L1 measurement results for candidate secondary cells (SCells) and identification information for at least one candidate SCell among the candidate SCells which is suggested to be activated,
determine target SCell information indicating an activated state or a de-activated state for each of the at least one candidate SCell, and
control the transceiver to transmit, to the DU of the source base station via the CU of the source base station, the target SCell information,
wherein SCell information associated with cell switch of a terminal is determined based on the target SCell information, and
wherein the SCell information includes information indicating the activated state or the deactivated state for each of at least one SCell among the candidate SCells.

14. The DU of the target base station of claim 13,
wherein the controller is further configured to control the transceiver to transmit, to the DU of the source base station via the CU of the source base station, load status information including information on a load status for each of the candidate SCells, and
wherein the SCell information is determined further based on the load status information.
